(19) United States
(12) Patent Application Publication
(10) Pub. No.: US 2025/0010569 A1
(43) Pub. Date: Jan. 9, 2025

(54) ARTICLES INCLUDING A SPACER AND ARTICLES INCLUDING A SLIT FILM AND PROCESSES FOR MAKING AND USING THE ARTICLES

(71) Applicant: 3M INNOVATIVE PROPERTIES COMPANY, St. Paul, MN (US)

(72) Inventors: Thomas R.J. Corrigan, St. Paul, MN (US); Ross J. DeVolder, Woodbury, MN (US); Cory M. Arthur, Eagan, MN (US); Dylan T. Cosgrove, Oakdale, MN (US); Jeffrey O. Emslander, City of Grant, MN (US); Anne C.F. Gold, South St. Paul, MN (US); Silvia G.B. Guttman, St. Paul, MN (US); Katelyn M. Leniczek, St. Paul, MN (US); Abhishek Srivastava, Minneapolis, MN (US); Aniruddha A. Upadhye, St. Paul, MN (US); Martin J.O. WidenBrant, Stillwater, MN (US)

(21) Appl. No.: 18/709,460

(22) PCT Filed: Dec. 15, 2022
(86) PCT No.: PCT/IB2022/062325

§ 371 Date: May 10, 2024

Related U.S. Application Data
(60) Provisional application No. 63/290,508, filed on Dec. 16, 2021.

(51) Int. Cl. B32B 3/12; B32B 1/00; B32B 3/26; B32B 27/08; B32B 27/20; B32B 27/32; E04B 1/70

(52) U.S. Cl. CPC B32B 3/12; B32B 1/00; B32B 3/266; B32B 27/08; B32B 27/20; B32B 27/32; E04B 1/7038; B32B 2270/00; B32B 2307/4026

(57) ABSTRACT

An article has first and second substrates with a spacer between them. The spacer includes beams connecting a plurality of walls, with openings between the beams. The plurality of walls includes multiple first, second, and third portions. The first and second portions are not parallel and have top and bottom edges that define a height of the wall and contact the first and second substrates, respectively. The third portions have top edges continuous with the top edges of the first and second portions but a smaller height than the height of the wall. At a given plane intersecting a first or second portion and perpendicular to the top and bottom edges, the thickness of at the top edge is plus or minus ten percent of the thickness at the bottom edge. The third portions are connected with some of the beams connecting the walls.

### BACKGROUND

Construction companies and builders often attach cladding panels to the structural frame of a building to form a non-structural facade of the building. Rainscreen products can provide a water drainage and ventilation gap between building sheathing and this exterior cladding. These products are applied exterior to the weather resistant barrier of a building and require an additional step to apply when utilized in building construction. Some rainscreen products can include furring strips, which are disposed between the cladding panels and the building structure to form an air gap. The air gap creates a capillary break which allows for drainage and evaporation of moisture. However, conventional furring strips can present several disadvantages, including susceptibility to rot and decay, inflexibility of installation location, and labor costs. In addition, conventional furring strips may be unable to physically support the use of nails or other similar fastening mechanisms. Other rainscreen products on the market are “drain in plane” systems that provide a mechanical supported gap across the entire sheathing. However, these “drain in plane” systems are costly and can limit ventilation due to the full coverage provided.

Certain articles reported to be using for rainscreen applications are disclosed in U.S. Pat. No. 9,453,337 (Fritz et al.); U.S. Pat. No. 9,856,642 (Ukrainetz); U.S. Pat. No. 10,233,637 (Barr); U.S. Pat. No. 10,676,918 (Caruso et al.); U.S. Pat. No. 10,914,077 (Roy et al.); U.S. Pat. Appl. Pub. No. 2012/0297711 (Ehrman et al.); and Int. Pat. Appl. Pub. Nos. WO 2006/046877 (Webster); and WO 2020/113033 (Koester et al.), and a flooring composite is disclosed in WO2021/122195 (Elzen).

In an unrelated technology, tension-activated, expanding sheets are described in Int. Pat. Appl. Pub. Nos. WO 2021/130616 (Corrigan et al.).

### SUMMARY

The present disclosure provides articles and methods of making and using the articles. The articles include film articles with slit portions that move into a position that is substantially orthogonal to the plane of the film when exposed to tension. The film articles can also include raised structures or adhesive. The articles further include spacers made from such slit films sandwiched between first and second substrates. The film can be conveniently stored and transported in a flat or roll format that uses minimal storage space and has a relatively low shipping weight; however, when the film is exposed to tension, it can form a three-dimensional structure with useful compressive strength.

In one aspect, the present disclosure provides an article that includes a first substrate, a second substrate, and a spacer between the first substrate and the second substrate. The spacer includes a plurality of walls spaced apart from each other and a plurality of beams connecting adjacent walls in the plurality of walls, with openings between the plurality of beams extending through the spacer. Each wall in the plurality of walls comprises multiple first, second, and third wall portions, in which the first and second wall portions are not parallel to each other and each have top and bottom opposing edges that define a height of the wall, in which the top edges contact the first substrate, and the bottom edges contact the second substrate. The third wall portions have top edges continuous with the top edges of the first and second wall portions but a smaller height than the height of the wall. The first, second, and third wall portions each have a thickness that is the smallest dimension of the wall portion, and at a given plane intersecting a first wall portion or second wall portion and perpendicular to the top edge and the bottom edge, a thickness of at the top edge is plus or minus ten percent of a thickness at the bottom edge. The third wall portions are connected with at least some of the plurality of beams connecting the adjacent walls.

In another aspect, the present disclosure provides an article including a film having a first direction and a second direction orthogonal to the first direction and defining a plane. The film includes a first plurality of slits through the film, and the first plurality of slits form a first row extending across the film in the second direction. Each slit in the first plurality of slits extends from a first terminal end to a second terminal end, in which the first terminal end is in a portion of the slit that extends in the first direction, and the second terminal end is in a portion of the slit that extends in the first direction. The film also includes a second plurality of slits through the film, and the second plurality of slits form a second row extending across the film in the second direction. Each slit in the second plurality of slits extends between terminal ends, in which the terminal ends are each in a portion of the slit that extends in the first direction. A first terminal end segment defining the first terminal end of each slit in the first plurality of slits intersects a first imaginary line connecting the terminal ends of a first slit in the second plurality of slits. The film further includes a rectangular region with a first axis in the first direction and a second axis in the second direction and an adhesive disposed in the rectangular region on at least one surface of the film. The rectangular region does not encompass the first terminal end or the second terminal end of any of the first plurality of slits or the terminal ends of any of the second plurality of slits.

In another aspect, the present disclosure provides an article including a film having a first direction and a second direction orthogonal to the first direction and defining a plane. The film includes raised structures extending in the first direction and spaced apart from each across the film in the second direction. The film includes a first plurality of slits through the film, and the first plurality of slits form a first row extending across the film in the second direction. Each slit in the first plurality of slits extends from a first terminal end to a second terminal end, in which the first terminal end is in a portion of the slit that extends in the first direction, and the second terminal end is in a portion of the slit that extends in the first direction. The film also includes a second plurality of slits through the film, and the second plurality of slits form a second row extending across the film in the second direction. Each slit in the second plurality of slits extends between terminal ends, in which the terminal ends are each in a portion of the slit that extends in the first direction. A first terminal end segment defining the first terminal end of each slit in the first plurality of slits intersects a first imaginary line connecting the terminal ends of a first slit in the second plurality of slits.

In another aspect, the present disclosure provides a process for using the aforementioned articles including a film. The process includes applying tension to the film along the first direction, which causes a plurality of regions of the film rotate relative to the plane to form a plurality of walls spaced apart from each other and a plurality of beams connecting adjacent walls in the plurality of walls.

In another aspect, the present disclosure provides a process for making the aforementioned articles including a spacer. The process includes applying tension to a film to make the spacer article, applying the spacer article to the first substrate, and applying the second substrate to the spacer article. The film has a first direction and a second direction transverse to the first direction and defines a pretensioned plane. The film further includes a first plurality of slits through the film, in which the first plurality of slits form a first row extending across the sheet in the second direction, and each slit in the first plurality of slits extends from a first terminal end to a second terminal end. The film further includes a second plurality of slits through the sheet, in which the second plurality of slits form a second row extending across the sheet in the second direction, and each slit in the second plurality of slits extends between terminal ends. A first terminal end segment defining the first terminal end of each slit in the first plurality of slits intersects a first imaginary line connecting the terminal ends of a first slit in the second plurality of slits. The tension is applied along the first direction, a plurality of regions of the polymer film rotate relative to the pretensioned plane to form the plurality of walls spaced apart from each other and the plurality of beams connecting adjacent walls in the plurality of walls.

In another aspect, the present disclosure provides use of an expandable slit film as a rainscreen between building sheathing and building cladding. The expandable slit film includes a film having a pretensioned state defining a pretensioned plane and a plurality of slits through the film. When tension is applied to the slit film, a plurality of regions of the film rotate relative to the pretensioned plane to form a rainscreen comprising a plurality of walls spaced apart from each other and a plurality of beams connecting adjacent walls in the plurality of walls.

In this application, terms such as “a”, “an” and “the” are not intended to refer to only a singular entity but include the general class of which a specific example may be used for illustration. The terms “a”, “an”, and “the” are used interchangeably with the term “at least one”. The phrase “at least one of” followed by a list refers to any one of the items in the list and any combination of two or more items in the list. All numerical ranges are inclusive of their endpoints and non-integral values between the endpoints unless otherwise stated.

The term “spaced-apart” refers to walls that have a distance between them. Similarly, the term “spaced-apart” refers to raised structures that are formed to have a distance between them. Spaced-apart” walls including the first wall portion, the second wall portion, the third wall portion, and the fourth wall portion do not touch each other in the spacer in the articles of the present disclosure. The bases of “spaced-apart” raised structures, where they are attached to the film, do not touch each other when the film is in an unbent configuration.

A “slit” is defined herein as a narrow cut through the article forming at least one line, which may be straight or curved, having at least two terminal ends. Slits described herein are discrete, meaning that individuals slits do not intersect other slits. A slit is generally not a cut-out, where a “cut-out” is defined as a surface area of the sheet that is removed from the sheet when a slit intersects itself. However, in practice, many forming techniques result in the removal of some surface area of the sheet that is not considered a “cut-out” for the purposes of the present application. In particular, many cutting technologies produce a “kerf”, or a cut having some physical width. For example, a laser cutter will ablate some surface area of the sheet to create the slit, a router will cut away some surface area of the material to create the slit, and even crush cutting creates some deformation on the edges of the material that forms a physical gap across the surface area of the material. Furthermore, molding techniques require material between opposing faces of the slit, creating a gap or kerf at the slit. In various embodiments, the gap or kerf of the slit will be less than or equal to the thickness of the material. For example, a slit pattern cut into a film that is 0.007″ (0.18 mm) thick might have slits with a gap that is approximately 0.007″ (0.18 mm) or less. However, it is understood that the width of the slit could be increased to a factor that is many times larger than the thickness of the material and be consistent with the technology disclosed herein.

When third and fourth wall portions are said to have top or bottom edges, respectively, continuous with the top and bottom edges of the first and second wall portions, it is meant that there is no interruption in the top edges between the first, second, and third wall portions and no interruption in the bottom edges between the first, second, and fourth wall portions.

### BRIEF DESCRIPTION OF THE DRAWINGS

The disclosure may be more completely understood in consideration of the following detailed description of various embodiments of the disclosure in connection with the accompanying drawings, in which:

FIG. 1 is an exploded perspective view of one embodiment of an article of the present disclosure;

FIG. 2 is a perspective side view schematic drawing of a spacer in one embodiment of an article of the present disclosure;

FIG. 3 is a top view schematic drawing of a film with a slit pattern useful for making the spacer of FIG. 2;

FIG. 4 is a perspective side view schematic drawing of a spacer in another embodiment of an article of the present disclosure;

FIG. 5 is a top view schematic drawing of a film with a slit pattern useful for making the spacer of FIG. 4;

FIG. 6 is a perspective side view schematic drawing of a spacer in yet another embodiment of an article of the present disclosure;

FIG. 7 is a top view schematic drawing of a film with a slit pattern useful for making the spacer of FIG. 4;

FIG. 8 is a top view schematic drawing of one embodiment of a film article of the present disclosure;

FIG. 9 is photograph of an embodiment similar to FIG. 8 after it is exposed to tension;

FIG. 10 is a top view schematic drawing of another embodiment of a film article of the present disclosure;

FIG. 11 is a nearly side view schematic drawing of the embodiment of FIG. 10 after it is exposed to tension;

FIG. 12 is a top view schematic drawing of yet another embodiment of a film article of the present disclosure;

FIG. 13 is a photograph of the embodiment of FIG. 12 after it is exposed to tension;

FIG. 14 is a top view schematic drawing of the laser slitting pattern used for the films of the examples;

FIG. 15 is a top view schematic drawing of yet another embodiment of a film article of the present disclosure; and

FIG. 16 is a photograph of an embodiment similar to FIG. 15 after it is exposed to tension.

### DETAILED DESCRIPTION

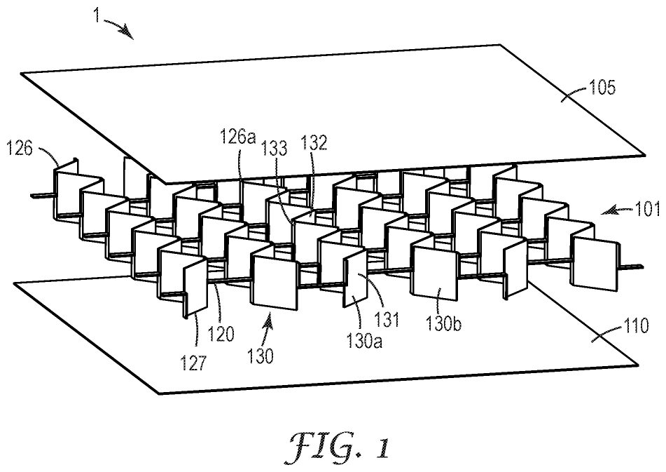

FIG. 1. illustrates an embodiment of an article according to the present disclosure. The article 1 includes a first substrate 105, a second substrate 110, and a spacer 101 between the first substrate 105 and the second substrate 110. The spacer includes a plurality of walls 130 spaced apart from each other and a plurality of beams 120 connecting adjacent walls 130a, 130b in the plurality of walls. Each wall in the plurality of walls 130 comprises multiple first, second, and third wall portions 131, 132, and 133. The first wall portions 131 and second wall portions 132 are not parallel to each other and each have top and bottom opposing edges that define a height of the wall 130, wherein the top edges 126 contact the first substrate 105 and the bottom edges 127 contact the second substrate 110 although such contact is not shown in the exploded view of FIG. 1. The third wall portions 133 have top edges 126a continuous with the top edges 126 of the first and second wall portions but a smaller height than the height of the wall, and wherein the third wall portions 133 are connected with at least some of the plurality of beams 120 connecting the adjacent walls 130a and 130b.

The first, second, and third wall portions each have a thickness (not shown in FIG. 1) that is the smallest dimension of the wall portion, and at a given plane intersecting a first wall portion or second wall portion and perpendicular to the top edge and the bottom edge, a thickness of at the top edge is plus or minus ten percent of a thickness at the bottom edge. In some embodiments, the thickness of at the top edge is plus or minus 9, 8, 7, 6, or 5 percent of a thickness at the bottom edge. Typically, the thickness at least at one of the top edges or bottom edges is plus or minus 10, 9, 8, 7, 6, or 5 percent of the thickness at an edge of one of the plurality of beams.

At least one of the first substrate 110 or the second substrate 105 comprises at least one of brick, concrete, stone, or a panel comprising at least one of wood, vinyl, metal, cement board, or a polymer composite. Useful metal substrates include aluminum and galvanized steel. Panels comprising wood may be made entirely of wood, such as pine, oak, maple, mahogany, cherry or any suitable hardwood or softwood. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding. In another example, the substrate can be a particle board comprising wood and wood byproduct particles and a binding resin. Other composite materials may be useful substrates. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic); metal matrix compositions, and ceramic matrix composites.

Articles of the present disclosure can be useful, for example, in building construction, in some embodiments, as a rainscreen. In some embodiments, the first or second substrate is an exterior sheathing material such as plywood, oriented strand board (OSB), particle board, chipboard, fiberboard, wood veneers, foam insulation sheathing, nonwoven glass mat faced gypsum sheathing board, exterior grade gypsum sheathing boards, or other conventional sheathing materials commonly used in the construction industry. Examples further include medium-density fiberboard, high-density fiberboard, and high moisture resistance board. In some embodiments, the first or second substrate is an exterior cladding material made up of brick, concrete blocks (e.g., concrete masonry units), reinforced concrete, stone, vinyl siding, fiber cement board, clapboard, or other known exterior siding materials. The substrate may be horizontal or vertical. In some embodiments, the article of the present disclosure and/or made by the process disclosed herein is at least a portion of an interior wall, an exterior wall, a floor, a ceiling, or a roof. In some embodiments, the article is part of a roofing deck, an attic floor or other attic surface, a boundary between a wall, roof system, and/or foundation, another interior or exterior surface of a structure, or used as flashing around a roof penetration. In some embodiments, the first substrate is flooring and the second substrate is concrete or vice versa.

The substrates, including any of those described above, may be untreated or treated, for example, with paint, a sealant, or other protective coating. The substrates may also include a waterproofing sheet disposed thereon. Useful waterproofing sheets may be constructed to provide the principal plane of air tightness through an environmental separator and that has an air permeance rate no greater than 0.02 L per square meter per second at a pressure difference of 75 Pa when tested in accordance with ASTM E 2178-13 and to provide acceptable barrier performance with respect to water according to AATCC 127-2013. In some embodiments, the waterproofing sheet is impermeable to liquid water at 55 cm of water pressure. In some embodiments, the waterproofing sheet is water vapor impermeable. However, waterproofing sheets useful in building construction may have both waterproofing capability and moisture permeability. Examples of such moisture-permeable waterproofing sheets include flash-spun nonwoven fabrics such as those described in U.S. Pat. No. 3,169,899 (Steuber) and U.S. Pat. No. 3,532,589 (David), which have a pore size appropriate to block water but allow water vapor to pass through. “Water vapor permeable” sheets may have a permeance of more than 1 perm (inch-pounds units) according to ASTM E 96 Procedure A (Desiccant Method). Commercially available waterproofing sheets include those obtained under the trade designation “TYVEK” from E. I. Du Pont de Nemours and Company, Wilmington, Delaware, “TYPAR” from Berry Global, Evansville, Indiana, and “3M Air and Vapor Barrier 3015” from 3M Company, St. Paul, Minnesota. Further useful waterproofing sheets include those described in U.S. Pat. Appl. Pub. Nos. 2017/0173916 (Widenbrant), 2018/0245332 (Widenbrant), and 2021/0207005 (Seabaugh), and U.S. Pat. No. 10,704,254 (Seabaugh), U.S. Pat. No. 11,105,089 (Widenbrant).

In addition to building construction, the articles of the present disclosure may also be useful for the construction of marine vessels (e.g., hulls), vehicles (e.g., body), and aircraft (e.g., the fuselage) and solar reflectors. The articles of the present disclosure may also be useful in road construction, bridges, and hard hats.

In the spacer of the present disclosure, the plurality of walls and the plurality of beams originate from a single sheet of film. The present disclosure also provides film articles. The single sheet of film has a pretensioned state defining a pretensioned plane and a plurality of slits through the film, wherein when tension is applied to the film, a plurality of regions of the film rotate relative to the pretensioned plane to form the spacer. The film can be made from a variety of materials including paper (e.g., cardboard, corrugated paper, coated or uncoated paper, kraft paper, cotton bond, and recycled paper), polymers (e.g., thermoplastics, thermosets, and elastomers), metals (e.g., aluminum), and woven and non-woven materials and/or fabrics. Examples of thermoplastics that can be used in the spacer or film article of the present disclosure include one or more of polyolefins (e.g., polyethylene (high density polyethylene (HDPE), medium density polyethylene (MDPE), low density polyethylene (LDPE), linear low density polyethylene (LLDPE)), metallocene polyethylene, and combinations thereof) and polypropylene (e.g., atactic and syndiotactic polypropylene)), polyamides (e.g., nylon), polyurethane, polyacetal (e.g., Delrin), polyacrylates, polyesters (e.g., polyethylene terephthalate (PET), polyethylene terephthalate glycol (PETG), and aliphatic polyesters such as polylactic acid), fluoroplastics (e.g., such as those obtained under the trade designation “THV” from 3M company, St. Paul, MN), and combinations thereof. Examples of thermoset materials can include one or more of polyurethanes, silicones, epoxies, melamine, phenol-formaldehyde resin, and combinations thereof. Examples of biodegradable polymers can include one or more of polylactic acid (PLA), polyglycolic acid (PGA), poly(caprolactone), copolymers of lactide and glycolide, poly(ethylene succinate), polyhydroxybutyrate, and combinations thereof.

The single sheet of film or film article of the present disclosure can be of any desired thickness. In some embodiments, the film has a thickness in a range from about 0.001 inch (0.025 mm) to about 5 inches (127 mm). In some embodiments, the film has a thickness in a range from about 0.005 inch (0.127 mm) to about 2 inches (51 mm). In some embodiments, the film has a thickness in a range from about 0.01 inch (0.25 mm) to about 1 inch (25.4 mm). In some embodiments where the film is a thermoplastic film, the thickness of the film is in a range from about 0.005 inch (0.13 mm) to about 0.125 inch (3.2 mm). In some embodiments, the thickness of the film is at least 0.001 inch (0.025 mm), or 0.005 inch (0.127 mm), or 0.01 inch (0.25 mm), or 0.05 inch (1.3 mm), or 0.1 inch (2.5 mm). In some embodiments, the thickness of the film is not more than 5 inches (127 mm) or 4 inches (101 mm), or 3 inches (76 mm), or 2 inches (51 mm), or 1 inch (25 mm), or 0.5 inch (13 mm), or 0.25 inch (6.3 mm), or 0.125 inch (3.2 mm).

The composition and thickness of the film in the article of the present disclosure and/or useful for generating the spacer in the article both contribute to a compression strength of the spacer when its top edges and bottom edges are compressed as in the test method described in the Examples below. Films made from compositions that are inherently softer can be made thicker to achieve a desired compression strength. Films made from compositions that are inherently stiffer may be useful at a variety of thicknesses such as any of those described above.

In some embodiments, the spacer has a compression strength of at least 10 kPa, 15 kPa, 20 kPa, or 25 kPa when measured according to ASTM D6364-06 with the top edges and bottom edges compressed between platens.

Referring again to FIG. 1, the height of the wall 130, which is defined as the distance between the top edges 126 and bottom edges 127 of the first and/or second wall portion, can vary depending on the design requirements of the spacer. In some embodiments, wall 130 has a height from the top of the ridges to the bottom of the troughs in a range 2 mm (0.08 inch) to 100 mm (3.9 inches), from 4 mm (0.16 inch) to 25 mm (0.98 inch), from 6 mm (0.24 inch) to 50 mm (2.0 inches), or from 5 mm (0.4 inches) to 15 mm (0.6 inches). The height of the wall may be, for example, in a range from 5 mm, 10 mm, or 15 mm up to 25 mm, 30 mm, 35 mm, 40 mm, 45 mm or 50 mm.

While in the embodiment illustrated in FIG. 1, the first substrate and the second substrate are planar, in some embodiments, the article of the present disclosure, including at least one of the first or second substrate, is curved (i.e., not flat, not planar). Advantageously, the spacer including the plurality of walls spaced apart from each other with adjacent walls connected by a plurality of beams are flexible and can easily conform to a concave surface or a convex surface. In some embodiments of the article of the present disclosure, a curved first or second substrate has a radius of curvature (e.g., up to about 10 meters, 5 meters, 3 meters, or 1 meter) in at least one direction. In some embodiments, at least one of the first or second substrate has radii of curvature in two orthogonal directions.

In some embodiments in which the article of the present disclosure is curved, at least one of the first substrate or the second substrate is formed into a predetermined shape before attaching the spacer to the substrate. The first substrate and/or substrate may be formed into a predetermined shape using any number of techniques known to those skilled in the art (e.g., stamping or using the curved surface of a forming jig). If a forming jig is used, its curved surface can be concave or convex, depending on the desired shape of the article.

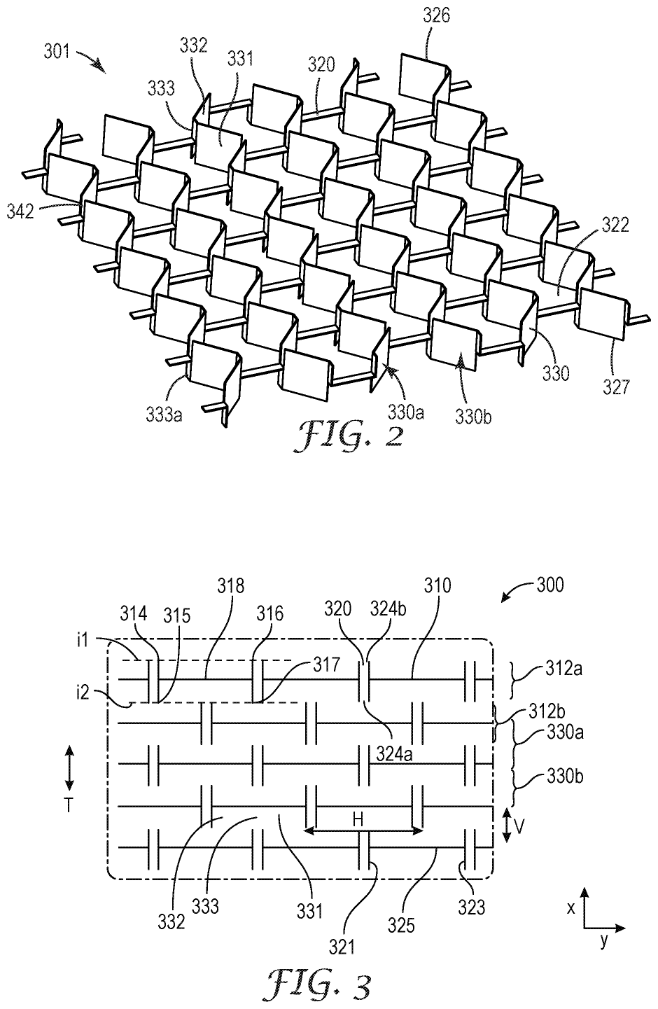

An embodiment of a spacer useful for practicing the present disclosure is illustrated in FIG. 2. The spacer 301 includes a plurality of walls 330 spaced apart from each other and a plurality of beams 320 connecting adjacent walls in the plurality of walls. Each wall in the plurality of walls 330 comprises multiple first, second, and third wall portions. The first wall portions 331 and second wall portions 332 are not parallel to each other and each have top and bottom opposing edges that define a height of the wall 330. The third wall portions 333 have top edges continuous with the top edges of the first and second wall portions 331, 332 but a smaller height than the height of the wall, and the third wall portions 333 are connected with at least some of the plurality of beams 320 connecting the adjacent walls 330a and 330b. The embodiment illustrated in FIG. 2 also has fourth wall portions 333a. The fourth wall portions 333a have bottom edges continuous with the bottom edges of the first and second wall portions 331, 332 but a smaller height than the height of the wall, and the fourth wall portions 333a are connected with others of the plurality of beams 320 connecting the adjacent walls 330a and 330b. The beams 320 are not continuous with the top edges 326 or the bottom edges 327 (in other words, not located at the top or bottom edges); instead, the beams connect adjacent walls at a location between the top edges 326 and the bottom edges 327. As shown in FIG. 2, the first, second, and third wall portions 331, 332, 333 each have a thickness that is their smallest dimension, and at a given plane intersecting a first wall portion 331 or second wall portion 332 and perpendicular to the top edge 326 and the bottom edge 327, a thickness of at the top edge 326 is plus or minus 10, 9, 8, 7, 6, or 5 percent of a thickness at the bottom edge 327.

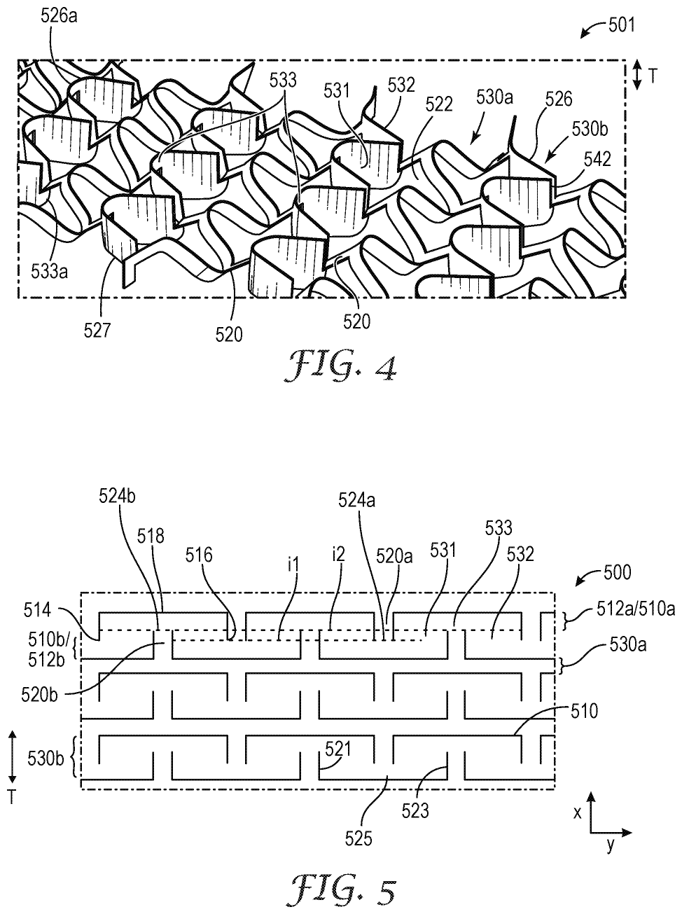

FIG. 3 is a top view illustrating the slit pattern made in a single sheet of film 300 useful for forming the spacer 301 illustrated in FIG. 2. In this embodiment, the slit pattern includes a plurality of slits 310 in rows of slits 312a and 312b. Each slit 310 includes a first axial portion 321, a second axial portion 323 that is spaced from and generally parallel to first axial portion 321, and a generally transverse portion 325 that connects first and second axial portions 321, 323. Each slit 310 includes four terminal ends: a first terminal end 314, a second terminal end 316, a third terminal end 315, and a fourth terminal end 317. Each slit 310 has a midpoint 318. The first terminal end 314 is aligned with the third terminal end 316 along an axis i1 in the transverse direction y, and the second terminal end 315 is aligned with the fourth terminal 317 end along an axis i2 in the transverse direction y.

The first plurality of slits form a first row 312a extending across the sheet in the second direction y, and each slit in the first plurality of slits extends from a first terminal end 314 or 315 to a second terminal end 316 or 317, wherein the first terminal end 314 or 315 is in a portion of the slit that extends in the first direction x, and wherein the second terminal end 316 or 317 is in a portion of the slit that extends in the first direction x. The second plurality of slits form a second row 312b extending across the sheet in the second direction y, and each slit in the second plurality of slits extends between terminal ends 314, 315 and 316, 317. The terminal ends 314, 315, 316, 317 are each in a portion of the slit that extends in the first direction x. A first terminal end segment defining the first terminal end 314 of each slit in the first plurality of slits intersects a first imaginary line i2 connecting the terminal ends of a first slit in the second plurality of slits.

The space between directly adjacent slits 310 in a row 312a, 312b can be referred to an axial beam 320. When exposed to tension, the axial beam 320 between adjacent slits 310 in a row 312a, 312b becomes a connecting beam 320 (shown in FIG. 2). The space bounded by the generally transverse portions 325 in rows 312a, 312b subtracting the connecting beams 320 defines the adjacent walls 330a, 330b.

The folding wall regions 330a, 330b in FIG. 3 have three generally rectangular regions 331, 332, and 333, where rectangular regions 331 and 332 are bound by (1) directly adjacent generally transverse portions 325 of slits 310 which are perpendicular to tension axis T and (2) adjacent axial portions 321 and 323 on directly adjacent, opposing slits 310. Axial beams 320 are between adjacent slits 310 in a single row 312a, 312b, more specifically, between the adjacent axial portions 321 and 323. Directly adjacent the beam 320 is a region 333 which is the remaining material in the folding wall region 330a, 330b bounded in the axial direction by the beam 320 and the generally transverse portion 325 and bounded in the transverse direction by the two generally rectangular regions 331, 332. Region 333 becomes the third wall portion or fourth wall portion 333a shown in FIG. 2. Directly adjacent rows of slits 310 are phase offset from one another.

The plurality of slits 310 in the single sheet of film 300 define columns and rows of axial beams 320 in which each of the axial beams 320 extends from a first folding wall region 330a to an adjacent second folding wall region 330b. Furthermore, each of the axial beams 320 define two termini 324a, 324b corresponding to the terminal ends of adjacent slits in a row. When tension is applied along the tension axis T (which in this embodiment is an axis nominally parallel to axial beams 320), folding wall regions 330 rotate out of plane and fold at the base of beams 320, and beams 320 do not rotate but draw closer together. The degree of fold or bend will vary depending on many factors including, for example, the stiffness or modulus of the material, the magnitude of the tension forces, the dimensions and scale of the elements, the width of non-rotating beams, the span between non-rotating beams, etc. The slit pattern shown in FIG. 3 results in the connecting beams 320 being staggered in the spacer 301 of FIG. 2. The motion of the non-rotating beams 320 and folding wall regions 330 produces openings 322, and a plurality of walls 330a, 330b connected by a plurality of beams 320 which are visible in FIG. 2.

An embodiment of another spacer useful for practicing the present disclosure is illustrated in FIG. 4. The spacer 501 includes a plurality of walls 530b spaced apart from each other and a plurality of beams 520 connecting adjacent walls in the plurality of walls. Each wall in the plurality of walls 530 comprises multiple first, second, and third wall portions. The first wall portions 531 and second wall portions 532 are not parallel to each other and each have top and bottom opposing edges 526, 527 that define a height of the wall 530b. The third wall portions 533 have top edges 526a continuous with the top edges of the first and second wall portions 531, 532 but a smaller height than the height of the wall, and the third wall portions 533 are connected with at least some of the plurality of beams 520 connecting the adjacent walls 530b. The embodiment illustrated in FIG. 4 also has fourth wall portions 533a. The fourth wall portions 533a have bottom edges continuous with the bottom edges of the first and second wall portions 531, 532 but a smaller height than the height of the wall, and the fourth wall portions 533a are connected with others of the plurality of beams 520 connecting the adjacent walls 530b. The adjacent walls 530b comprise first and second walls, wherein the at least some of the plurality of beams connect to the third wall portions 533 of the first wall and to the fourth wall portion 533a of the second wall, wherein the at least others of the plurality of beams connect to the fourth wall portions 533a of the first wall and to the third wall portions 533 of a third wall, opposite the second wall, and wherein the plurality of beams further comprise a ribbon 530a having an undulating shape. The beams 520 are not continuous with the top edges 526 or the bottom edges 527 in other words, not located at the top or bottom edges); instead, the beams connect adjacent walls at a location between the top edges 526 and the bottom edges 527. As shown in FIG. 4, the first, second, and third wall portions 531, 532, 533 each have a thickness that is their smallest dimension, and at a given plane intersecting a first wall portion 531 or second wall portion 532 and perpendicular to the top edge 526 and the bottom edge 527, a thickness of at the top edge 526 is plus or minus 10, 9, 8, 7, 6, or 5 percent of a thickness at the bottom edge 527.

FIG. 5 is a top view illustrating the slit pattern made in a single sheet of film 500 useful for forming the spacer illustrated in FIG. 4. The slit pattern of FIG. 5 includes a first set of rows 512a that include a first plurality of slits 510a extending across the sheet in the transverse direction y, where the first plurality of slits 510a have a first shape and position. The first plurality of slits 510a is a repeating pattern of slits. The first set of rows 512a alternate with a second set of rows 512b along the axial length of the sheet. Each of the second set of rows 512b is defined by a second plurality of slits 510b extending across the sheet in the transverse direction y. The second plurality of slits 510b is a repeating pattern of slits. The second set of rows 512b includes slits having the same slit shape but the slits 510b are positioned differently (in this case, inverted and axially offset). Slits 510 each include a first terminal end 514, a second terminal end 516, and a midpoint 518. The first plurality of slits 510a define a first plurality of axial beams 520a that is the material between the slits 510a. The second plurality of slits 510b define a second plurality of axial beams 520b between the slits 510b.

In the embodiment illustrated in FIG. 5, the second plurality of slits 510b nest or overlap with another slit 510 in a directly adjacent row, specifically with the first plurality of slits 510a in the current example. Each of the slits in the second plurality of slits 510b extend through a first imaginary line i1 that connects the terminal ends 514, 516 of a slit in the first plurality of slits 510a. Similarly, each of the slits in the first plurality of slits 510a extend through a second imaginary line i2 that connects the terminal ends 514, 516 of a slit in the second plurality of slits 510b. Furthermore, each beam 520 in the first plurality of beams 520a has a terminus 524a that extends through a transverse axis (overlapping with the second imaginary line i2) defined by a terminus 524b of a beam of the second plurality of beams 520b. Similarly, each beam 520 in the second plurality of beams 520b has a terminus 524b that extends through a transverse axis (overlapping with the first imaginary line i1) defined by a terminus 524a of a beam of the first plurality of beams 520a.

Because the terminal ends 514, 516 of slits 510 in directly adjacent rows 512a and 512b overlap, such that a single line (nominally transverse) will pass through a portion of all of the axial portions 521 and 523 of all slits 510 in the overlapped rows 512a and 512b, the size and shape of regions 530a and 530b are different. The continuous transverse region between the generally transverse portions (which are substantially perpendicular to the tension axis T) forms a first ribbon 530a. This ribbon only occurs once between every two sets of overlapped rows 512a and 512b. Overlapped rows 512a and 512b are arranged such that there is no continuous transverse region between the terminal ends 514, 516 of slits 510 in the directly adjacent, overlapped, row. The overlapped row of slits 512a and 512b comprises a folding wall region 530b. The folding wall region can be further described as having two generally rectangular regions 531, 532 that are bounded in the axial direction by adjacent generally transverse portions 525 on opposing sides of the folding wall region 530b and bounded in the transverse direction by adjacent axial portions 521 and 523 on opposing sides of slit 510. The axial beam 520a, 520b is present between adjacent slits 510 in a single row 512a or 512b. Directly adjacent the beam 520b is a region 533 which is the remaining material in the folding wall region 530b bounded in the axial direction by the beam 520b and the generally transverse portion 525 and bounded in the transverse direction by the two adjacent generally rectangular regions 531, 532. Region 533 becomes the third wall portion or fourth wall portion 533a shown in FIG. 4.

Axial beams 520a, 520b are arranged in columns extending the axial length of the single sheet of film 500. The axial beams 520a, 520b extend axially through an adjacent portion of each transverse ribbon 530a that intersects the axial beam 520a, 520b. Transverse portions 525 of slits 510 are generally arranged between each of the axial beams 520a, 520b in each respective column such that the axial beams 520a, 520b within a column are separated from each other by a transverse portion 525 of a slit.

This nesting or overlap of slits 510a and 510b is optional. As described above, the slits have two terminal ends 514, 516. A straight, imaginary line extends between and connects these terminal ends. In some embodiments, the straight, imaginary line extending between and connecting the terminal ends 514, 516 of a first slit 510a is substantially colinear with the straight, imaginary line extending between and connecting the terminal ends 514, 516 of a directly adjacent slit 510b.

Those of skill in the art will appreciate that many changes may be made to the pattern while still falling within the scope of the present disclosure. For example, the slit length or shape, row size or shape, and/or beam size or shape can vary. Further, the pattern can alternate in 2 rows, 3 rows, 4 rows, or more. Further, the degrees of offset or phase offset can vary from what is shown. Even further, many of the examples herein depict and describe slits that have axial portions intersecting a transverse portion at about a 90° angle to form a corner. In various embodiments, however the axial portions of slits may intersect a transverse portion to form a rounded corner. In some other embodiments, there is no discernible transition between the axial portions and the transverse portion, such as where the slit defines a semi-circle.

When tension is applied along tension axis T, different things to happen ribbon region 530a and folding wall region 530b. The ribbon region 530a bends into a shape that undulates to bring the axial beam 520a between adjacent slits 510 closer to the adjacent beam 520a in the same row, while keeping the terminal ends 514 and 516 approximately in a single plane that is parallel to the original plane of material 500 in its pretensioned state. The folding wall region 530b rotates and folds into an accordion-like shape such that the generally rectangular regions 531, 532, and 533 have folds between two generally rectangular regions 531 and 532 and regions 533, and have a single common axis (that in the flat state was the axial axis) that rotates at least 90 degrees from the original plane of the single sheet of film 500 in its pretensioned state. The rotation of the common axis can also be understood and even calculated when it is considered as an additional consequence of all the terminal ends 514 and 516 being pulled into the same plane. These movements in sheet 500 form a series of openings 522 and two distinct folded regions 530a, 530b, one of which 530b is rotated at least orthogonal to the tension axis and the original plane of sheet 500 in its pretensioned state, as seen in FIG. 4.

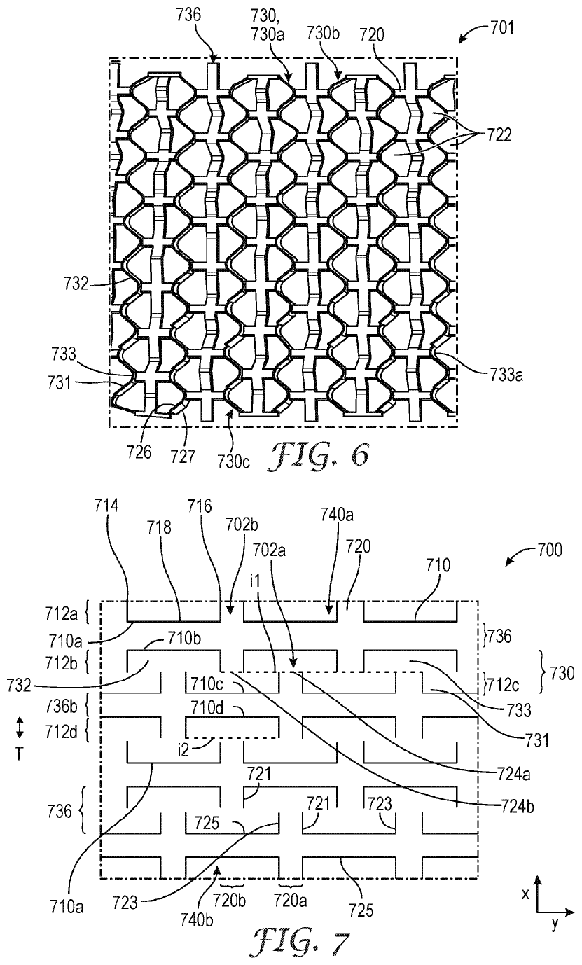

An embodiment of another spacer useful for practicing the present disclosure is illustrated in FIG. 6. The spacer 701 includes a plurality of walls 730 spaced apart from each other and a plurality of beams 720 connecting adjacent walls in the plurality of walls. Each wall in the plurality of walls 730 comprises multiple first, second, and third wall portions. The first wall portions 731 and second wall portions 732 are not parallel to each other and each have top and bottom opposing edges 726, 727 that define a height of the wall 730. The third wall portions 733 have top edges continuous with the top edges of the first and second wall portions 731, 732 but a smaller height than the height of the wall, and the third wall portions 733 are connected with at least some of the plurality of beams 720 connecting adjacent walls 730a, 730b in the plurality of walls 730. The embodiment illustrated in FIG. 6 also has fourth wall portions 733a. The fourth wall portions 733a have bottom edges continuous with the bottom edges of the first and second wall portions 731, 732 but a smaller height than the height of the wall, and the fourth wall portions 733a are connected with others of the plurality of beams 720 connecting adjacent walls in the plurality of walls 730. The adjacent walls 730 comprise first and second walls, 730a, 730b, wherein the at least some of the plurality of beams connect to the third wall portions 733 of the first wall 730a and to the fourth wall portion 733a of the second wall 730b, wherein the at least others of the plurality of beams connect to the fourth wall portions 733a of the first wall 730a and to the third wall portions 733 of a third wall 730a, opposite the second wall 730b, and wherein the plurality of beams further comprise a ribbon 736 having an undulating shape.

The beams 720 are not continuous with the top edges 726 or the bottom edges 727 in other words, not located at the top or bottom edges); instead, the beams connect adjacent walls at a location between the top edges 726 and the bottom edges 727. As shown in FIG. 6, the first, second, and third wall portions 731, 732, 733 each have a thickness that is their smallest dimension, and at a given plane intersecting a first wall portion 731 or second wall portion 732 and perpendicular to the top edge 726 and the bottom edge 727, a thickness of at the top edge 726 is plus or minus 10, 9, 8, 7, 6, or 5 percent of a thickness at the bottom edge 727.

FIG. 7 is a top view illustrating the slit pattern made in a single sheet of film 700 useful for forming the spacer 701 illustrated in FIG. 6. In the illustrated embodiment, the slit pattern of FIG. 7 includes a first set of rows 712a that include slits 710 of a first shape and position and a second set of rows 712b that includes the same slit shape but the slits 710 are positioned differently (in this case, inverted) and offset in the axial direction x. The slit shape in both the first set of rows 712a and the second set of rows 712b is substantially the same except for the inversion. In addition to being positioned differently, the slits of FIG. 7 are such that the terminal ends of the slits 710 in adjacent rows are aligned along a transverse axis, or the slits 710 in one row extend past an axis defined by the terminal ends of the slits 710 in an adjacent row creating a nested arrangement.

A plurality of individual slits 710 are aligned to form rows 712 that are generally perpendicular to tension axis T. Each slit of the plurality of slits includes a first terminal end 714, a second terminal end 716, and a midpoint 718. Slits 710 include two generally axial portions 721, 723 that are generally parallel to the tension axis T and that are connected to a generally transverse portion 725 that is generally perpendicular to the tension axis T.

The plurality of slits 710 define a plurality of axially extending beams 720 arranged in columns along the axial length of the sheet. The plurality of slits 710 form a first plurality of axial beams 720a forming a first column 702a. A transverse portion 725 of a slit of the plurality of slits 710 is disposed axially between beams 720a. Each series of two beams 720a in the first column 702a alternates with a series of two transverse portions 725 of corresponding slits 710 in the column. As such, the first column 702a has a first group of slits 740a each having a transverse portion 725 that is axially between beams in the first plurality of beams 720a. The plurality of slits 710 also defines a second plurality of beams 720b extending in the axial direction x. The second plurality of beams 720b form a second column 702b extending across the sheet 700 in the axial direction x. The second plurality of beams 720b are spaced from the first plurality of beams 720a in the transverse direction y. Between beams 720b in the axial direction x is a transverse portion 725 of a slit in a second group of slits 740b of the plurality of slits 710. Similar to the first column 702a, there is a series of two consecutive beams 720b alternating with two consecutive transverse portions 725 of slits along the length of the column 702b.

The first plurality of beams 720a and the second plurality of beams 720b are staggered in the axial and transverse directions. In the illustrated embodiment, each slit in the first group of slits 740a has an axial portion 721 that defines a beam in the second plurality of beams 720b. Each slit in the second group of slits 740b of the plurality of slits 710 has an axial portion 723 that defines a beam in the first plurality of beams 720a. Each beam of the first plurality of beams 720a is aligned with axis (i1, as an example) defined by a terminus 724b of a beam of the second plurality of beams 720b.

The single sheet of film 700 includes first slits 710a, second slits 710b, third slits 710c, and fourth slits 710d, each forming a corresponding first row 712a, second row 712b, third row 712c and fourth row 712d, respectively. Each row of slits extends across the width of the sheet of film 700 in the transverse direction y. The first row 712a, second row 712b, third row 712c and fourth row 712d form a repeating pattern of rows along the axial length of the sheet of material 700. In the current example, the second slits 710b are nested with the third slits 710c and the first slits 710a are nested with the fourth slits 710d. As such, a first terminal end segment 721 defining the first terminal end 714 of each slit in the second plurality of slits 710b intersects an imaginary line i1 connecting the terminal ends 714, 716 of a slit in the third plurality of slits 710c. In the illustrated embodiment, a first terminal end 714 of each slit in the second plurality of slits 710b is aligned with the imaginary line i1 connecting the terminal ends 714, 716 of a slit in the third plurality of slits 710c. Similarly, a first terminal end segment (corresponding to the first axial portion 721) defining the first terminal end 714 of each slit in the first plurality of slits 710a intersects an imaginary line i2 connecting the terminal ends 714, 716 of a slit in the fourth plurality of slits 710d. In the illustrated embodiment, a first terminal end 714 of each slit in the first plurality of slits 710a is aligned with the imaginary line i2 connecting the terminal ends 714, 716 of a slit in the fourth plurality of slits 710d.

First slits 710a and second slits 710b form transverse sides or edges of a portion of a first transverse ribbon 736. The first transverse ribbon 736 extends across the transverse width of the material 700. The length of the first transverse ribbon 736 across the width of the material is uninterrupted by intervening slits. The second slits 710b and the third slits 710c form a folding wall region 730. The folding wall region generally includes all the area enclosed by the second slits 710b and the third slits 710c, which excludes the axial beams 720 between adjacent slits 710b,710c. The third slits 710c and the fourth slits 710d form transverse sides or edges of a portion of a second transverse ribbon 736b. The transverse ribbons 736 and 736b are directly adjacent folding wall region 730, which is between the first transverse ribbon 736 and the second transverse ribbon 736b. Slits 710a and 710b are substantially aligned with one another. Slits 710c and 710d substantially aligned with one another. Slits 710b and 710c are not aligned with one another. Instead, slits 710b and 710c are phase separated or spaced from one another. In the embodiment of FIG. 7, slits 710 are substantially perpendicular to the tension axis T.

The continuous transverse region between the generally transverse portions 725 (which are substantially perpendicular to the tension axis T) forms a transverse ribbon 736. This ribbon only occurs once between every two sets of transversely aligned, directly adjacent rows 712a and 712b. The area of the single sheet of film 700 into which the slits 710 with transversely aligned terminal ends 714, 716 extend, subtracting the axial beam 720 between adjacent slits 710, comprises a folding wall region 730. The folding wall region 730 can be further described as having generally rectangular regions 731, 732, and 733, where rectangular regions 731 and 732 are bound by (1) directly adjacent generally transverse portions 725 of slits 710 which are perpendicular to the tension axis and (2) adjacent axial portions 721 and 723 on directly adjacent, opposing slits 710. The axial beam 720 is present between adjacent slits 710 in a single row 712. Directly adjacent the axial beam 720 is a region 733 which is the remaining material in the folding wall region 730 bounded in the axial direction x by the beam 720 and the generally transverse portion 725 and bounded in the transverse direction y by the two generally rectangular regions 731, more specifically by the axial extensions of the adjacent axial portions 721 and 723.

In the embodiment illustrated in FIG. 7, the slits 710 have two terminal ends. A straight, imaginary line i1 extends between and connects these terminal ends. In this embodiment, the straight, imaginary line extending between and connecting the terminal ends of a first slit 710b is substantially colinear with the straight, imaginary line extending between and connecting the terminal ends of a directly adjacent slit 710c. In this embodiment, all of the straight, imaginary lines extending between and connecting the slit terminal ends in a single row are approximately colinear.

When exposed to tension along the tension axis T, the transverse beams 730 bend into a shape that undulates to bring the axial beam 720 between adjacent slits closer to the adjacent beam 720 in the same row, while keeping the terminal ends 714 and 716 approximately in a single plane that is parallel to the original plane of material 700 in its pretensioned state. The undulating transverse ribbon 736 is perpendicular to the tension axis. The folding wall region 730 rotates and folds into an accordion-like shape such that there are folds between all adjacent generally rectangular regions 731, 732, 733, and all flat surfaces are nominally orthogonal to the original plane of material 700 in its pretensioned state. The axial beam 720 between adjacent slits 710 in a row 712 primarily experiences tension aligned with tension axis T, this tension is balanced by the adjacent beam 720 that adjoins the same transverse beam 730 so this region or area tends to stay flat and parallel to the original plane of material 700 in its pretensioned state. These movements in material 700 form openings 722 and two distinct folded regions, 1) undulating ribbons 736 that are perpendicular to the tension axis, and 2) folded beams 730 that are orthogonal to the original plane of material 700 in its pretensioned state, as seen in FIG. 6.

As shown in FIGS. 2, 4, and 6 the plurality of walls 330a, 330b, 530b, 730a, and 730b can be substantially 90 degrees or orthogonal to the original plane of the single sheet of film 300 in its pretensioned state) when tension-activated. This can provide compressive strength and stability to the spacer. The folded wall, or accordion shaped wall, or rotating/folding wall has a large area moment of inertia (also called moment of area or second moment of inertia) in the deployed article (deployed via the application of tension or force) where the area moment of inertia is in the plane of the original sheet and the relative bending axis is perpendicular to the tension axis. The area moment of inertia is increased relative to a straight vertical wall without folds. “Substantially 90 degrees” means that the plurality of walls and original plane of the single sheet can deviate from each other by up to 10 degrees (in some embodiments up to 7.5, and in some embodiments up to 5 degrees) from 90 degrees.

In some embodiments of the spacer useful for practicing the present disclosure, the spaces between the plurality of walls including openings 322, 522, 722 allow airflow in a first direction. Adjacent walls 330a, 330b, and 730a, 730b, for example, define airflow channels in a first direction. Openings 342, 542 (FIGS. 2, 4) in at least some portions of the plurality of walls allow airflow in a second direction transverse to the first direction. The openings are defined by the third wall portions and fourth wall portions 333, 333a, 533, 533a, and 733, which have a smaller height than the height of the walls 322, 522, 722. In some embodiments, the second direction is perpendicular to the first direction. In some embodiments, the second flow channels are generally horizontally disposed across the spacer. In some embodiments, the second flow channels are staggered or tortuous, but an air flow path across the spacer in the second direction is maintained. Additionally, second air flow channels need not be in register with each other. As shown in FIG. 2, for example, some of the second flow channels are aligned with the top edges of the plurality of walls while some of the second flow channels are aligned with the bottom edges of the plurality of walls. The air flow allowed in two directions by at least some embodiments of the spacers can be useful, for example, when the spacer is used as a rainscreen between the exterior sheathing and the siding of a building. In some embodiments, channels created by openings 322, 342, 522, 542, 722 in the spacer may be filled with insulation (e.g., foam insulation) instead of providing air flow channels.

Most of the slit patterns shown herein have regions that are described as rotating either upward or downward relative to the original plane of the sheet when tension is applied. The distinction between upward and downward motion is an arbitrary description used for clarity to substantially match the accompanying figures. The samples could all be flipped over turning the downward motions into upward motions and vice versa. In addition, it is normal and expected for occasional inversions to occur where the regions of the sample will flip such that similar features which had moved upward in previous regions are now moving downward and vice versa. These inversions can occur for regions as small as a single slit, or large portions of the material. These inversions are random and natural, they are a result of natural variations in materials, manufacturing, and applied forces.

All the slit patterns shown herein include single slits that are out of phase with one another by approximately one half of the transverse spacing between directly adjacent slits (or 50% of the transverse spacing). However, the patterns may be out of phase by any desired amount including one third of the transverse spacing, one quarter of the transverse spacing, one sixth of the transverse spacing, and one eighth of the transverse spacing, for example. In some embodiments, the phase offset is less than 1 or less than three fourths, or less than one half of the transverse spacing of directly adjacent slits in a row. In some embodiments, the phase offset is more than one fiftieth, or more than one twentieth, or more than one tenth of the transverse spacing of directly adjacent slits in a row.

In some embodiments, the minimum phase offset is such that the terminal ends of slits in alternate rows intersect a line parallel to the tension axis through the terminal ends of slits in the adjacent rows. In some embodiments, the maximum phase offset is similarly limited by the creation of a continuous path of material. If the width of the slits orthogonal to the tension axis are constant for all slits and have a value w and the gap between slits orthogonal to the tension axis are constant and have a value g, then the minimum phase offset equals g/(w+g), and the maximum phase offset equals w/(w+g).

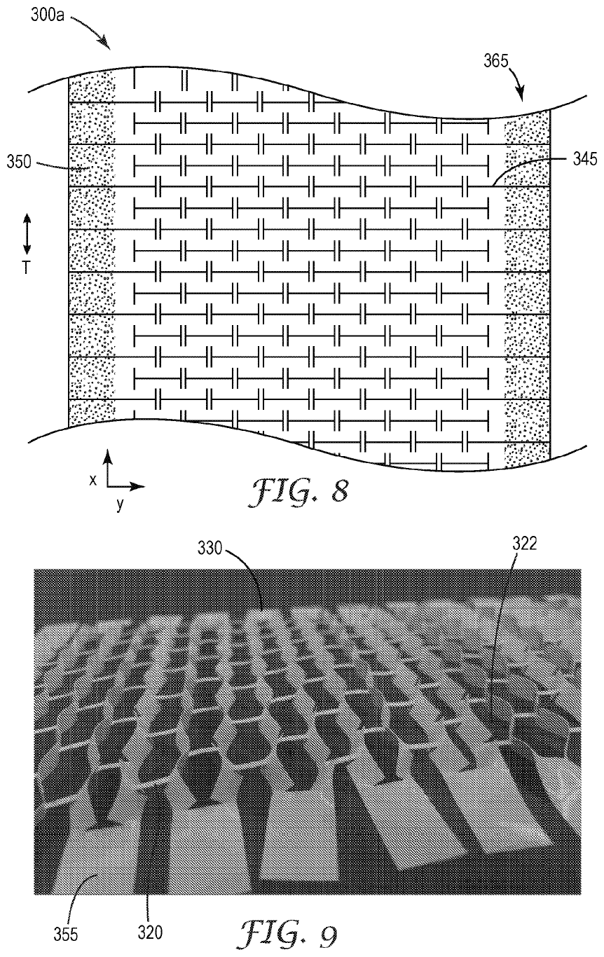

In some embodiments, including the embodiments illustrated in FIGS. 3, 5, and 7, the slit pattern extends substantially to one or more of the edges of the single sheet of film. In some embodiments, the film article or spacer described herein includes edge material that does not include the slit pattern. The edge material can be a down-web border 365 as shown in FIG. 8, which in some embodiments is a rectangle whose long axis is parallel to the tension axis T and has any desired length and can be drawn on the substrate without overlapping or touching terminal ends of slits in the slit pattern. In the embodiment illustrated in FIG. 8, the edge material includes slits 345 that reach the edges of the slit film, but these slits 345 do not include slits in the repeating slit pattern, and the down-web border 365 does not include terminal ends of slits.

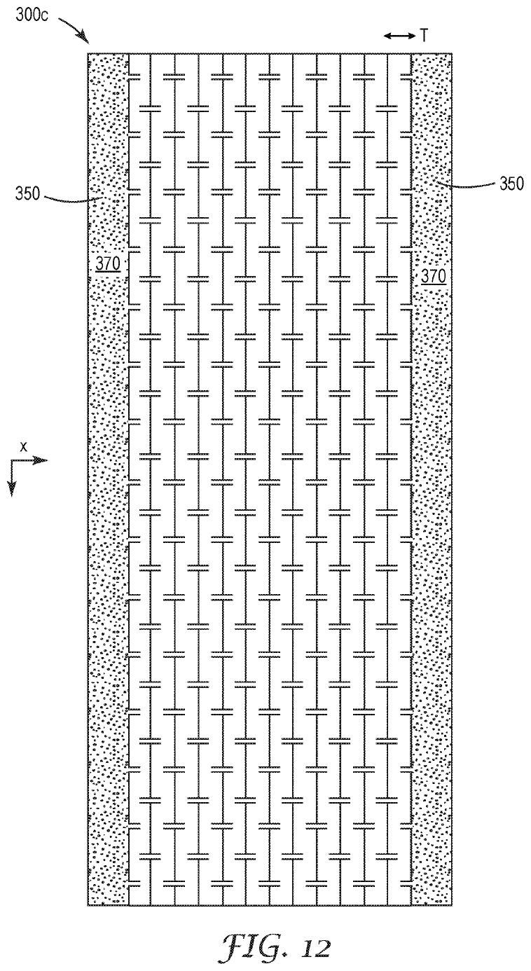

In some embodiments, the edge material can be a down-web or cross-web border 370 as shown in FIG. 12, which in some embodiments is a rectangle whose long axis is perpendicular to the tension axis T and has any desired length and can be drawn on the substrate without overlapping or touching terminal ends of slits in the slit pattern. In the embodiment illustrated in FIG. 12, the borders of the edge material are defined by slits, but the edge material does not include terminal ends of slits. In some embodiments, edge material of any width may be added to the borders of a finite length article to make the article easier to deploy by applying tension.

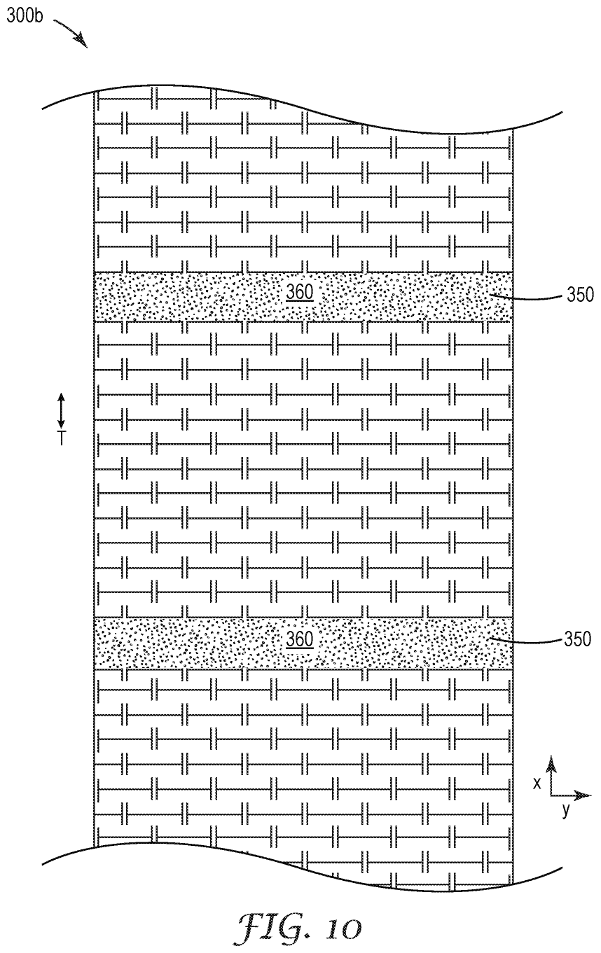

In some embodiments, including the embodiments illustrated in FIGS. 3, 5, and 7, the slit pattern extends substantially continuously across the surface of the single sheet of film. In some embodiments, the film article or spacer described herein includes cross-web or down-web slabs that do not include the slit pattern. Cross-web slabs can be defined as rectangular regions with a rectangle whose long axis is perpendicular to the tension axis and has any desired length and whose width is any finite number and can be drawn on the substrate without overlapping or touching terminal ends of slits in the slit pattern. In some embodiments, including the embodiment illustrated in FIG. 10, cross-web slabs 360 are added intermittently to a continuously patterned film. In the embodiment illustrated in FIG. 10, the borders of the cross-web slab 360 is defined by slits, but cross-web slab 360 does not include terminal ends of slits.

The cross-web slabs and edge material can have any useful length and/or width (long dimension and short dimension, respectively. In some embodiments, the width of the edge material or cross-web slab is at least 0.010 inch (0.25 mm) or at least 0.10 inch (2.5 mm). In some embodiments, the width of the edge material or cross-web slab is not more than 1 foot (305 mm), 6 inches (152 mm), 5 inches (127 mm), 3 inches (76.2 mm), 2 inches (51 mm), or 1 inch (25.4 mm). In some embodiments the width of the edge material or cross-web slab is in a range from 0.25 mm, 2.5 mm, 5 mm, 10 mm, 15 mm, 20 mm, 25 mm, or 50 mm up to 610 mm, 305 mm, 152 mm, 127 mm, 76.2 mm, 51 mm, or 25 mm.

The single sheets of film and slit articles described herein can be made in a number of different ways. For example, the slit patterns can be formed by extrusion, molding, laser cutting, water jetting, machining, stereolithography or other 3D printing techniques, laser ablation, photolithography, chemical etching, rotary die cutting, stamping, other suitable negative or positive processing techniques, or combinations thereof. In some embodiments, a single sheet of film can be fed into a nip consisting of a rotary die and an anvil. The rotary die has cutting surfaces on it that correspond to the pattern desired to be cut into the sheet of film. The die cuts through the film in desired places and forms the slit pattern described herein. The same process can be used with a flat die and flat anvil.

Referring again to FIG. 8, a film article according to some embodiments of the present disclosure is illustrated. Film article 300a includes a sheet having a first direction x and a second direction y. The sheet has a first plurality of slits through the sheet and a second plurality of slits through the sheet. The first plurality of slits and the second plurality of slits are as described above in connection with FIG. 3. The film article 300a includes rectangular region (down-web border 365), with a long axis in first direction x, parallel to the tension axis T, which does not overlap or touch terminal ends of slits in the slit pattern. In the embodiment illustrated in FIG. 8, the rectangular region includes slits 345 that reach the edges of the film article, but these slits 345 do not include slits in the slit pattern, and the rectangular region does not include terminal ends of slits. Film article includes an adhesive 350 disposed in the rectangular region on at least one surface of the sheet.

When tension is applied along the tension axis T (which in this embodiment is an axis nominally parallel to axial beams 320), folding wall regions rotate out of plane and fold at the base of beams 320 to form a plurality of walls 330, as shown in FIG. 9 and as described in greater detail above in connection with FIG. 2. Slits 345 that reach the edges of the film article result in flaps 355. With adhesive disposed on at least one surface of the sheet, flaps 355 can be adhered to a substrate (e.g., a first substrate or second substrate as described above in any of their embodiments) to hold the plurality of walls 330 and openings 322 in place.

Referring again to FIG. 10, a film article according to some embodiments of the present disclosure is illustrated. Film article 300b includes a sheet having a first direction x and a second direction y. The sheet has a first plurality of slits through the sheet and a second plurality of slits through the sheet. The first plurality of slits and the second plurality of slits are as described above in connection with FIG. 3. The film article 300b includes rectangular region (cross-web slab 360), with a long axis in second direction y, perpendicular to the tension axis T, which does not overlap or touch terminal ends of slits in the slit pattern. In the embodiment illustrated in FIG. 10, the rectangular region has borders that are defined by slits, but the rectangular region does not include terminal ends of slits. Film article includes an adhesive 350 disposed in the rectangular region (cross-web slab 360) on at least one surface of the sheet.

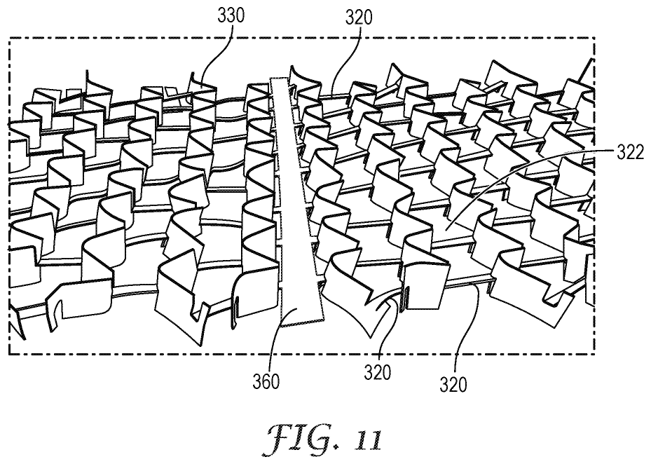

When tension is applied along the tension axis T (which in this embodiment is an axis nominally parallel to axial beams 320), folding wall regions rotate out of plane and fold at the base of beams 320 to form a plurality of walls 330, as shown in FIG. 11 and as described in greater detail above in connection with FIG. 2. With adhesive disposed on at least one surface of the sheet, rectangular regions (cross-web slabs 360) can be adhered to a substrate (e.g., a first substrate or second substrate as described above in any of their embodiments) to hold the plurality of walls 330 and openings 322 in place.

Referring again to FIG. 12, a film article according to some embodiments of the present disclosure is illustrated. Film article 300c includes a sheet having a first direction x and a second direction y. The sheet has a first plurality of slits through the sheet and a second plurality of slits through the sheet. The first plurality of slits and the second plurality of slits are as described above in connection with FIG. 3. The film article 300c includes rectangular region (border 370), with a long axis in second direction y, perpendicular to the tension axis T, which does not overlap or touch terminal ends of slits in the slit pattern. In the embodiment illustrated in FIG. 12, the rectangular region has borders that are defined by slits, but the rectangular region does not include terminal ends of slits. Film article includes an adhesive 350 disposed in the rectangular region on at least one surface of the sheet.

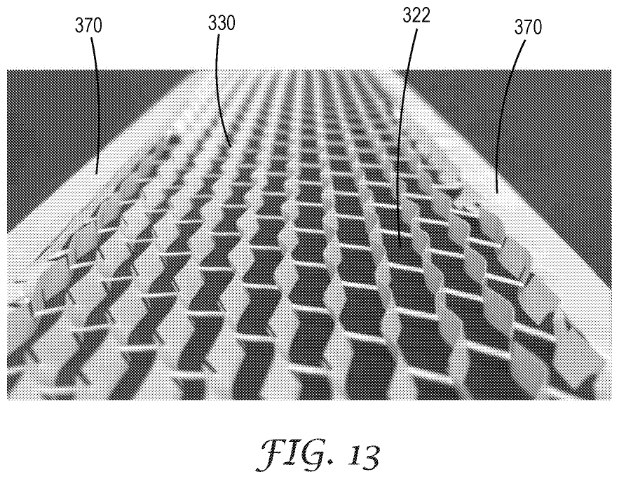

When tension is applied along the tension axis T (which in this embodiment is an axis nominally parallel to axial beams 320), folding wall regions 330 rotate out of plane and fold at the base of beams 320 to form a plurality of walls, as shown in FIG. 13 and as described in greater detail above in connection with FIG. 2. With adhesive disposed on at least one surface of the sheet, rectangular regions (borders 370) can be adhered to a substrate (e.g., a first substrate or second substrate as described above in any of their embodiments) to hold the plurality of walls 330 and openings 322 in place.

Adhesive can also be applied to the transverse ribbon region 736 shown in FIG. 7 to make a film article according to the present disclosure. When tension is applied along the tension axis T shown in FIG. 7, folding wall regions 730 rotate out of plane and fold at the base of beams 720 to form a plurality of walls, as shown in FIG. 6. With adhesive disposed on at least one surface of the sheet in the transverse ribbon region 736 (FIG. 7), undulating ribbons 736 (FIG. 6) can be adhered to a substrate (e.g., a first substrate or second substrate as described above in any of their embodiments) to hold the plurality of walls 730 and openings 722 in place.

A variety of adhesives may be useful for practicing the present disclosure, for example, on the film article of the present disclosure or for attaching the spacer disclosed herein to at least one of the first or second substrates. In some embodiments, the adhesive is a structural adhesive that is applied to at least one of the film article of the present disclosure or the first substrate or second substrate as described above and subsequently cured. Useful structural adhesives include two-part curable adhesives (e.g., an epoxy resin or acrylic adhesive) and moisture-curable adhesives. Several useful structural adhesives are commercially available (e.g., an epoxy adhesive available from 3M Company, St. Paul, MN under the trade designation “SCOTCHWELD DP420”). Useful structural adhesive also include one-part curable adhesives such as those curable with ultraviolet or blue light.

The adhesive can be in the form of a film or foam. In some embodiments, the adhesive layer is a single layer. In some embodiments, the adhesive is one layer of a multilayer adhesive construction such as a double sided adhesive tape. For example, the multilayer adhesive tape can have a first adhesive skin layer, a second adhesive skin layer, and a core layer positioned between the first adhesive skin layer and the second adhesive skin layer. The core layer is often a foam backing layer and can be an adhesive or non-adhesive foam. In another example, the multilayer adhesive tape can have a first adhesive layer, a film backing, and a second adhesive layer. The film backing can be an adhesive or non-adhesive layer. Examples of useful adhesive include an acrylic foam pressure sensitive adhesive tape available from 3M Company under the trade designation “VHB TAPE 4920” and structural bonding tapes available from 3M Company under the trade designation “9244”.

In some embodiments, the adhesive is a pressure sensitive adhesive (PSA), which also may be applied to at least one of the film article of the present disclosure or the first substrate or second substrate as described above. PSAs are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power.

One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m². A variety of PSAs may be useful on the article of the present disclosure. Examples of suitable PSAs include natural rubber-, acrylic-, block copolymer-, silicone-, polyisobutylene-, polyvinyl ether-, polybutadiene-, or and urea-based pressure sensitive adhesive and combinations thereof. These PSAs can be prepared, for example, as described in Adhesion and Adhesives Technology, Alphonsus V. Pocius, Hanser/Gardner Publications, Inc., Cincinnati, Ohio, 1997, pages 216 to 223; Handbook of Pressure Sensitive Adhesive Technology, Donatas Satas (Ed.), 2nd Edition, Van Nostrand Reinhold, New York, NY, 1989, Chapter 15; and U.S. Pat. No. Re 24,906 (Ulrich).

One example of a useful class of pressure-sensitive adhesives are based on (meth)acrylate copolymers. The (meth)acrylate copolymers typically have a glass transition temperature (Tg) that is no greater than 20° C., no greater than 10° C., no greater than 0° C., no greater than −10° C., no greater than −20° C., no greater than −30° C., no greater than −40° C., or no greater than −50° C. The glass transition temperature can be measured using techniques such as Differential Scanning Calorimetry and Dynamic Mechanical Analysis. Alternatively, the glass transition temperature can be estimated using the Fox equation based on the monomers used to form the adhesive. Lists of glass transition temperatures for homopolymers are available from multiple monomer suppliers such as from BASF Corporation (Houston, TX, USA), Polyscience, Inc. (Warrington, PA, USA), and Aldrich (St. Louis, MO, USA) as well as in various publications such as, for example, Mattioni et al., J. Chem. Inf. Comput. Sci., 2002, 42, 232-240.

The (meth)acrylate copolymers typically are formed from a monomer composition that contains at least one low Tg monomer. As used herein, the term “low Tg monomer” refers to a monomer having a Tg no greater than 20° C. when homopolymerized (i.e., a homopolymer formed from the low Tg monomer has a Tg no greater than 20° C.). Suitable low Tg monomers are often selected from an alkyl (meth)acrylates, heteroalkyl (meth)acrylates, aryl substituted alkyl acrylate, and aryloxy substituted alkyl acrylates.

Examples of low Tg alkyl (meth)acrylate monomers often are non-tertiary alkyl acrylates but can be alkyl methacrylates having a linear alkyl group with at least 4 carbon atoms. Specific examples of alkyl (meth)acrylates include n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, and n-dodecyl methacrylate. Isomers and mixture of isomers of these monomers can be used.

Examples of low Tg heteroalkyl (meth)acrylate monomers often have at least 3 carbon atoms, at least 4 carbon atoms, or at least 6 carbon atoms and can have up to 30 or more carbon atoms, up to 20 carbon atoms, up to 18 carbon atoms, up to 16 carbon atoms, up to 12 carbon atoms, or up to 10 carbon atoms. Specific examples of heteroalkyl (meth)acrylates include 2-ethoxyethyl acrylate, 2-(2-ethoxyethoxy)ethyl acrylate, 2-methoxyethyl (meth)acrylate, and tetrahydrofurfuryl (meth)acrylate.

Examples of low Tg aryl substituted alkyl acrylates or aryloxy substituted alkyl acrylates include 2-biphenylhexyl acrylate, benzyl acrylate, 2-phenoxyethyl acrylate, and 2-phenylethyl acrylate.

Some monomer compositions for (meth)acrylate copolymers can include an optional polar monomer. The polar monomer has an ethylenically unsaturated group and a polar group such as an acidic group or a salt thereof, a hydroxyl group, a primary amido group, a secondary amido group, a tertiary amido group, or an amino group. Having a polar monomer often facilitates adherence of the pressure-sensitive adhesive to a variety of substrates.

Examples of polar monomers with an acidic group include ethylenically unsaturated carboxylic acids, ethylenically unsaturated sulfonic acids, ethylenically unsaturated phosphonic acids, and mixtures thereof. Examples of such compounds include acrylic acid, methacrylic acid, itaconic acid, fumaric acid, crotonic acid, citraconic acid, maleic acid, oleic acid, beta-carboxyethyl (meth)acrylate, 2-sulfoethyl methacrylate, styrene sulfonic acid, 2-acrylamido-2-methylpropanesulfonic acid, vinyl phosphonic acid, and mixtures thereof. Due to their availability, the acid monomer is often acrylic acid or methacrylic acid.

Examples of polar monomers with a hydroxyl group include hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, PA, USA) under the trade designation CD570, CD571, and CD572), and aryloxy substituted hydroxyalkyl (meth)acrylates (e.g., 2-hydroxy-2-phenoxypropyl (meth)acrylate).

Examples of polar monomers with a primary amido group include (meth)acrylamide. Examples of polar monomers with secondary amido groups include N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide.

Examples of polar monomers with a tertiary amido group include N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

A monomer composition for (meth)acrylate copolymers can optionally include a high Tg monomer. As used herein, the term “high Tg monomer” refers to a monomer that has a Tg greater than 30° C., greater than 40° C., or greater than 50° C. when homopolymerized (i.e., a homopolymer formed from the monomer has a Tg greater than 30° C., greater than 40° C., or greater than 50° C.). Some suitable high Tg monomers have a single (meth)acryloyl group such as methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, 2-phenoxyethyl methacrylate, N-octyl (meth)acrylamide, and mixtures thereof. Other suitable high Tg monomers have a single vinyl group that is not a (meth)acryloyl group such as, for example, various vinyl ethers (e.g., vinyl methyl ether), vinyl esters (e.g., vinyl acetate and vinyl propionate), styrene, substituted styrene (e.g., alpha-methyl styrene), vinyl halide, and mixtures thereof. Vinyl monomers having a group characteristic of polar monomers are considered herein to be polar monomers.

Still further, the monomer composition for (meth)acrylate copolymers can optionally include a vinyl monomer (i.e., a monomer with an ethylenically unsaturated group that is not a (meth)acryloyl group). Examples of optional vinyl monomers include various vinyl ethers (e.g., vinyl methyl ether), vinyl esters (e.g., vinyl acetate and vinyl propionate), styrene, substituted styrene (e.g., alpha-methyl styrene), vinyl halide, and mixtures thereof. Vinyl monomers having a group characteristic of polar monomers are considered herein to be polar monomers.

Overall the pressure-sensitive adhesive can contain up to 100 weight percent (e.g., 100 weight percent) low Tg monomer units. The weight percent value is based on the total weight of monomeric units in the polymeric material. In some embodiments, the (meth)acrylate polymer contains 40 to 100 weight percent of the low Tg monomeric units, 0 to 15 weight percent polar monomeric units, 0 to 50 weight percent high Tg monomeric units, and 0 to 15 weight percent vinyl monomeric units. In some embodiments, the (meth)acrylate polymer contains 60 to 100 weight percent of the low Tg monomeric units, 0 to 10 weight percent polar monomeric units, 0 to 40 weight percent high Tg monomeric units, and 0 to 10 weight percent vinyl monomeric units. In some embodiments, the (meth)acrylate polymer contains 75 to 100 weight percent of the low Tg monomeric units, 0 to 10 weight percent polar monomeric units, 0 to 25 weight percent high Tg monomeric units, and 0 to 5 weight percent vinyl monomeric units.

Further examples of suitable pressure-sensitive adhesives include those including elastomers such as polybutadiene, polyisoprene, polychloroprene, random and block copolymers of styrene and dienes (e.g., SBR), and ethylene-propylene-diene monomer rubber. For this class pressure-sensitive adhesive, the elastomer is typically combined with tackifying resins. In some embodiments, the adhesives of this class are like those described, for example, in U.S. Pat. No. 9,556,367 (Waid et al.). The adhesive is a pressure-sensitive adhesive and contains 92 to 99.9 parts of a block copolymer adhesive composition and 0.1 to less than 10 parts of an acrylic adhesive composition. The block copolymer adhesive composition comprises a first block copolymer comprising at least one rubbery block comprising a first polymerized conjugated diene, a hydrogenated derivative thereof, or combinations thereof and at least one glassy block comprising a first polymerized mono-vinyl aromatic monomer. The acrylic adhesive composition comprises 70 to 100 parts of at least one acrylic or methacrylic ester of a non-tertiary alkyl alcohol, wherein the non-tertiary alkyl alcohol contains 4 to 20 carbon atoms; and 0 to 30 parts of a copolymerized reinforcing monomer.

In some embodiments, the first block copolymer is a multi-arm block copolymer of the formula Qₙ-Y, wherein Q represents an arm of the multi-arm block copolymer, n represents the number of arms and is a whole number of at least 3, and Y is the residue of a multifunctional coupling agent. Each arm, Q, independently has the formula R-G where R represents the rubbery block and G represents the glassy block. In some embodiments, the first block copolymer is a polymodal, asymmetric star block copolymer.

In some embodiments, the pressure sensitive adhesive further comprises a second block copolymer. The second block copolymer contains at least one rubbery block and at least one glassy block. The rubbery block comprises a polymerized second conjugated diene, a hydrogenated derivative thereof, or combinations thereof and the glassy block comprises a second polymerized mono-vinyl aromatic monomer. In some embodiments, the second block copolymer is a linear block copolymer.

The pressure-sensitive adhesive can further comprise a first high Tg tackifier having a Tg of at least 60° C., wherein the first high Tg tackifier is compatible with at least one rubbery block. In some embodiments, the block copolymer adhesive composition further comprises a second high Tg tackifier having a Tg of at least 60° C., wherein the second high Tg tackifier is compatible with the at least one glassy block.

Further examples of adhesives useful for practicing the present disclosure include pressure-sensitive and hot melt applied adhesives prepared from non-photopolymerizable monomers. Such polymers can be adhesive polymers (i.e., polymers that are inherently adhesive), or polymers that are not inherently adhesive but can form adhesive compositions when compounded with components such as plasticizers and/or tackifiers. Specific examples include poly-alpha-olefins (e.g., polyoctene, polyhexene, and atactic polypropylene), block copolymer-based adhesives, natural and synthetic rubbers, silicone adhesives, ethylene-vinyl acetate, and epoxy-containing structural adhesive blends (e.g., epoxy-acrylate and epoxy-polyester blends).

Further examples of polymers useful for adhesives include semi-crystalline polymer resins, such as polyolefins and polyolefin copolymers (e.g., polymer resins based upon monomers having between 2 and 8 carbon atoms, such as low-density polyethylene, high-density polyethylene, polypropylene, and ethylene-propylene copolymers); polyesters and co-polyesters; polyamides and co-polyamides; fluorinated homopolymers and copolymers; polyalkylene oxides (e.g., polyethylene oxide and polypropylene oxide); polyvinyl alcohol; ionomers (e.g., ethylene-methacrylic acid copolymers neutralized with a base); and cellulose acetate. Other examples of polymers useful for adhesives include amorphous polymers such as polyacrylonitrile polyvinyl chloride, thermoplastic polyurethanes, aromatic epoxies, polycarbonates, amorphous polyesters, amorphous polyamides, ABS block copolymers, polyphenylene oxide alloys, ionomers (e.g., ethylene-methacrylic acid copolymers neutralized as salts), fluorinated elastomers, and polydimethyl siloxane.

Adhesives useful for practicing the present disclosure optionally contain other components such as fillers, antioxidants, viscosity modifiers, pigments, tackifying resins, and fibers. These components can be added to the adhesive to the extent that they do not alter the desired properties of the final product. The adhesive, if desired, can be at least partially crosslinked by electron beam (“E-beam”) radiation or other crosslinking mechanisms (e.g., chemical, heat, gamma radiation, and/or ultraviolet and/or visible radiation) using processes known in the art. Crosslinking can be useful, for example, for imparting desirable characteristics (e.g., increased strength) to the adhesive.

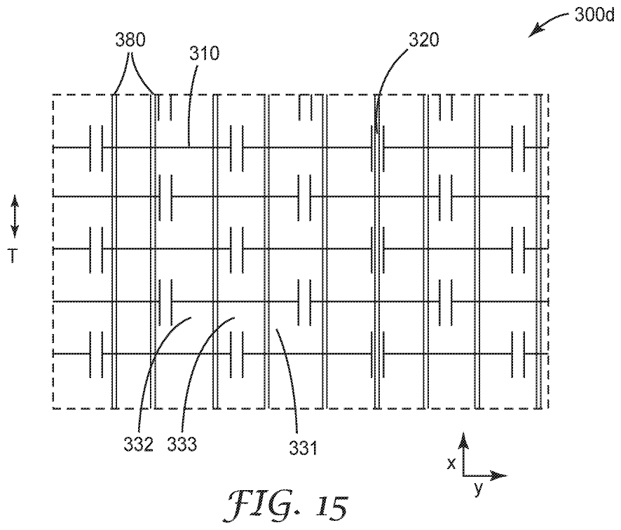

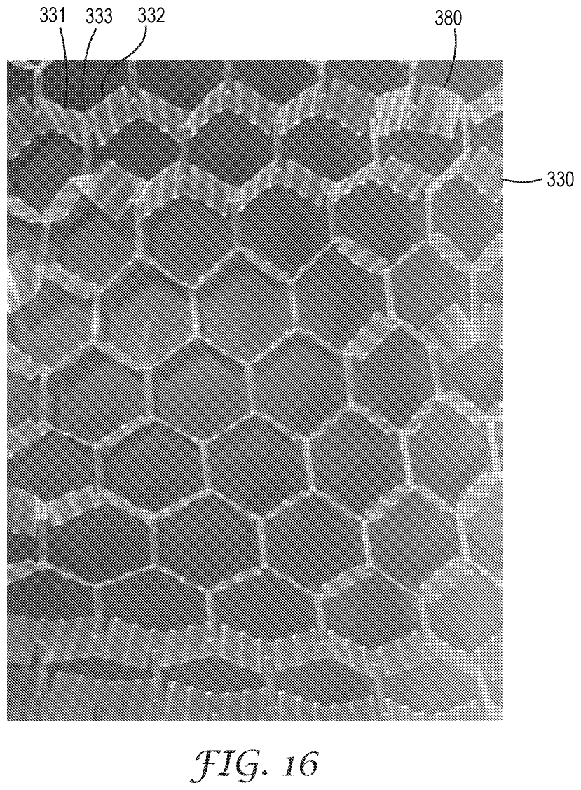

Another embodiment of a film article according to the present disclosure is illustrated in FIG. 15. Film article 300d includes a sheet having a first direction x and a second direction y. The sheet has a first plurality of slits 310 through the sheet and a second plurality of slits through the sheet. The first plurality of slits 310 and the second plurality of slits are as described above in connection with FIG. 3. The film article 300d includes raised structures 380 parallel to the tension axis T. In some embodiments, including the embodiment illustrated in FIG. 15, the raised structures are continuous in the first direction x parallel to the tension axis T although this is not a requirement. The raised structures may be in the form of ribs or ridges protruding from the film.

When tension is applied along the tension axis T (which in this embodiment is an axis nominally parallel to axial beams 320), folding wall regions rotate out of plane and fold at the base of beams 320 to form a plurality of walls 330, as shown in FIG. 16 and as described in greater detail above in connection with FIG. 2. Furthermore, the raised structures rotate out of plane with the folding wall regions and orient vertically in the spacer. The raised structures provide increased thickness in portions of the first and second wall portions 331, 332, which can increase the compression strength of the spacer when its top edges and bottom edges are compressed as in the test method described in the Examples below. See, for example, Film Example 1 in the Examples below in Table 3 in comparison to Films A to D. An increase in compression strength results even when the thickness of the top and bottom edges is not uniformly increased. Advantageously, the raised structures can provide an increase in compression strength in the spacer while saving material costs. Even with an increase in thickness, the first, second, and third wall portions 331, 332, 333 each have a thickness that is their smallest dimension, and at a given plane intersecting a first wall portion 331 or second wall portion 332 and perpendicular to the top edge 326 and the bottom edge 327, a thickness of at the top edge 326 is plus or minus 10, 9, 8, 7, 6, or 5 percent of a thickness at the bottom edge 327. The raised structures may be formed on the film on one or both surfaces, followed by slitting the film as described above. The raised structures may be in the first and second wall portions 331, 332, in the third wall portions and axial beams 320, or both as shown in FIG. 15.

Raised structures 380 may be made on a film in any convenient way. When using blown film techniques, an extruder includes an annular die head orifice that is configured to produce a tubular stalk having continuous rails extending radially outward from its peripheral outer surface. The die head can have an opening comprised of a circular bore with radially extending cavities located at predetermined intervals along its circumference. The cavities can have any desired cross-sectional shape to provide a desired shape in the raised structures. A mandrel disposed within the die head opening cooperates with the bore to form an annular orifice, which as a shape defined by the die gap between bore and mandrel and the configuration of cavities. The stalk is formed when molten resin is forced through the annular orifice. As the stalk is extruded through the annular orifice of die head, it is drawn (e.g., pulled) downstream, along the axis of extrusion, typically by rollers at a predetermined take-up speed. The pulling can be controlled to cause desirable stretching of stalk in the extrusion direction. As a result of such stretching, the stalk experiences axial elongation and a reduction in its wall thickness, or “gauge”. At the same time the stalk is pulled downstream, it is inflated by a gas bubble (e.g., an air bubble) trapped within its hollow interior. The radial expansion increases the diameter of the stalk and further decreases its gauge. Further details of making a blown film with raised structures can be found, for example, in U.S. Pat. No. 7,137,736 (Pawloski et al.) and U.S. Pat. No. 9,090,005 (Libby et al.).

Another useful method for forming raised structures on a film is profile extrusion described, for example, in U.S. Pat. No. 4,894,060 (Nestegard). Typically, in this method a thermoplastic flow stream is passed through a patterned die lip (e.g., cut by electron discharge machining) to form a web having downweb ridges.

The raised structures made by any of these extrusion methods may be in the final form determined by the shape of the die, or one or more capping processes may be useful for changing the shape of the raised structures.

Because the articles described herein are flat when manufactured, shipped, sold, and stored and only become three-dimensional when activated with tension/force by the user, these articles are more effective and efficient at making the best use of storage space and minimizing shipping/transit/packaging costs. Retailers and users can use relatively little space to house a product that will expand to 10 or 20 or 30 or 40 or more times its original size.

In a first embodiment, the present disclosure provides an article comprising
a first substrate;
a second substrate; and
a spacer between the first substrate and the second substrate, the spacer comprising a plurality of walls spaced apart from each other and a plurality of beams connecting adjacent walls in the plurality of walls, with openings between the plurality of beams extending through the spacer,
wherein each wall in the plurality of walls comprises multiple first, second, and third wall portions, wherein the first and second wall portions are not parallel to each other and each have top and bottom opposing edges that define a height of the wall, wherein the top edges contact the first substrate and the bottom edges contact the second substrate, wherein the third wall portions have top edges continuous with the top edges of the first and second wall portions but a smaller height than the height of the wall, wherein the first, second, and third wall portions each have a thickness that is the smallest dimension of the wall portion, wherein at a given plane intersecting a first wall portion or second wall portion and perpendicular to the top edge and the bottom edge, a thickness of at the top edge is plus or minus ten percent of a thickness at the bottom edge, and wherein the third wall portions are connected with at least some of the plurality of beams connecting the adjacent walls. The plurality of beams are generally not located at the top edges or the bottom edges.

In a second embodiment, the present disclosure provides the article of the first embodiment, wherein the plurality of walls and the plurality of beams originate from a single sheet of film.

In a third embodiment, the present disclosure provides the article of the second embodiment, wherein the single sheet of film has a pretensioned state defining a pretensioned plane and a plurality of slits through the film, wherein when tension is applied to the film, a plurality of regions of the film rotate relative to the pretensioned plane to form the plurality of walls.

In a fourth embodiment, the present disclosure provides the article of the second or third embodiment, wherein the single sheet of film has a first direction and a second direction transverse to the first direction and comprises:
a first plurality of slits through the sheet, wherein the first plurality of slits form a first row extending across the sheet in the second direction, and wherein each slit in the first plurality of slits extends from a first terminal end to a second terminal end; and
a second plurality of slits through the sheet, wherein the second plurality of slits form a second row extending across the sheet in the second direction, wherein each slit in the second plurality of slits extends between terminal ends, wherein a first terminal end segment defining the first terminal end of each slit in the first plurality of slits intersects a first imaginary line connecting the terminal ends of a first slit in the second plurality of slits.

In a fifth embodiment, the present disclosure provides the article of any one of the second to fourth embodiments, wherein the single sheet of film is a multi-layer polymeric film and/or comprises at least one of a polymer or metal.

In a sixth embodiment, the present disclosure provides the article of any one of the first to fifth embodiments, wherein at least one of the first substrate or the second substrate comprises brick, concrete, stone, or a panel comprising at least one of wood, vinyl, metal, cement board, or a polymer composite.

In a seventh embodiment, the present disclosure provides the article of any one of the first to sixth embodiments, wherein at least one of the first substrate or the second substrate is curved.

In an eighth embodiment, the present disclosure provides the article of any one of the first to sixth embodiments, wherein at least one of the first substrate or the second substrate is planar.

In a ninth embodiment, the present disclosure provides the article of any one of the first to eighth embodiments, wherein each wall in the plurality of walls further comprises fourth wall portions, wherein the fourth wall portions have bottom edges continuous with the bottom edges of the first and second wall portions but a smaller height than the height of the wall, and wherein the fourth wall portions are connected with others of the plurality of beams connecting the adjacent walls.

In a tenth embodiment, the present disclosure provides the article of the ninth embodiment, wherein the adjacent walls comprise first and second walls, wherein the at least some of the plurality of beams connect to the third wall portions of the first and second walls, and wherein the others of the plurality of beams connect to the fourth wall portions of the first wall and a third wall, opposite the second wall.

In an eleventh embodiment, the present disclosure provides the article of the ninth embodiment, wherein the adjacent walls comprise first and second walls, wherein the at least some of the plurality of beams connect to the third wall portions of the first wall and to the fourth wall portions of the second wall, wherein the others of the plurality of beams connect to the fourth wall portions of the first wall and to the third wall portions of a third wall.

In a twelfth embodiment, the present disclosure provides the article of any one of the first to eleventh embodiments, wherein the plurality of beams further comprises a ribbon having an undulating shape.

In a thirteenth embodiment, the present disclosure provides the article of any one of the first to twelfth embodiments, wherein the spacer has a compression strength of at least 10 kPa when measured according to ASTM D6364-06 with the top edges and bottom edges compressed between platens.

In a fourteenth embodiment, the present disclosure provides the article of any one of the first to thirteenth embodiments, wherein the first and second wall portions further comprise raised structures extending from the top edges to the bottom edges.

In a fifteenth embodiment, the present disclosure provides the article of any one of the first to fourteenth embodiments, wherein the spacer is at least one of fastened or adhered to at least one of the first substrate, the second substrate, or both the first substrate and the second substrate.

In a sixteenth embodiment, the present disclosure provides an article comprising:
a film having a first direction and a second direction orthogonal to the first direction and defining a plane, the film comprising:
a first plurality of slits through the film, wherein the first plurality of slits form a first row extending across the film in the second direction, and wherein each slit in the first plurality of slits extends from a first terminal end to a second terminal end, wherein the first terminal end is in a portion of the slit that extends in the first direction, and wherein the second terminal end is in a portion of the slit that extends in the first direction;
a second plurality of slits through the film, wherein the second plurality of slits form a second row extending across the film in the second direction, wherein each slit in the second plurality of slits extends between terminal ends, wherein the terminal ends are each in a portion of the slit that extends in the first direction, wherein a first terminal end segment defining the first terminal end of each slit in the first plurality of slits intersects a first imaginary line connecting the terminal ends of a first slit in the second plurality of slits;
a rectangular region with a first axis in the first direction and a second axis in the second direction, wherein the rectangular region does not encompass the first terminal end or the second terminal end of any of the first plurality of slits or the terminal ends of any of the second plurality of slits; and
an adhesive disposed in the rectangular region on at least one surface of the film.

In a seventeenth embodiment, the present disclosure provides the article of the sixteenth embodiment, further comprising:
a third plurality of slits through the film, wherein the third plurality of slits form a third row extending across the film in the second direction, and wherein each slit in the third plurality of slits extends from a first terminal end to a second terminal end, wherein the first terminal end is in a portion of the slit that extends in the first direction, and wherein the second terminal end is in a portion of the slit that extends in the first direction; and
a fourth plurality of slits through the film, wherein the fourth plurality of slits form a fourth row extending across the film in the second direction, wherein each slit in the fourth plurality of slits extends between terminal ends, wherein the terminal ends are each in a portion of the slit that extends in the first direction, wherein a first terminal end segment defining the first terminal end of each slit in the third plurality of slits intersects a first imaginary line connecting the terminal ends of a first slit in the fourth plurality of slits, wherein the third plurality of slits and the fourth plurality of slits form a mirror image of the first plurality of slits and the second plurality of slits;
wherein the rectangular region is a ribbon region extending across the film in the second direction between the second plurality of slits and the third plurality of slits, wherein the rectangular region does not encompass the first terminal end or the second terminal end of any of the third plurality of slits or the terminal ends of any of the second plurality of slits.

In an eighteenth embodiment, the present disclosure provides the article of the sixteenth or seventeenth embodiment, the film further comprising raised structures extending in the first direction and spaced apart from each across the film in the second direction.

In a nineteenth embodiment, the present disclosure provides an article comprising:
a film having a first direction and a second direction orthogonal to the first direction and defining a plane, the film comprising:
raised structures extending in the first direction and spaced apart from each across the film in the second direction;
a first plurality of slits through the film and through the raised structures, wherein the first plurality of slits form a first row extending across the film in the second direction, and wherein each slit in the first plurality of slits extends from a first terminal end to a second terminal end, wherein the first terminal end is in a portion of the slit that extends in the first direction, and wherein the second terminal end is in a portion of the slit that extends in the first direction; and
a second plurality of slits through the film, wherein the second plurality of slits form a second row extending across the film in the second direction, wherein each slit in the second plurality of slits extends between terminal ends, wherein the terminal ends are each in a portion of the slit that extends in the first direction, wherein a first terminal end segment defining the first terminal end of each slit in the first plurality of slits intersects a first imaginary line connecting the terminal ends of a first slit in the second plurality of slits.

In a twentieth embodiment, the present disclosure provides the article of the sixteenth, eighteenth or nineteenth embodiment, wherein each slit in the first plurality of slits and the second plurality of slits comprises more than two terminal ends, for example, four terminal ends.

In a twenty-first embodiment, the present disclosure provides the article of any one of the sixteenth to twentieth embodiments, wherein the film comprises at least one of a polymer or a metal.

In a twenty-second embodiment, the present disclosure provides the article of any one of the sixteenth to twenty-first embodiments, wherein the adhesive is a pressure sensitive adhesive or a structural (that is, curable) adhesive.

In a twenty-third embodiment, the present disclosure provides a process for using the article of any one of the sixteenth to twenty-second embodiments, the process comprising:
applying tension to the film along the first direction, thereby causing a plurality of regions of the film rotate relative to the plane to form a plurality of walls spaced apart from each other and a plurality of beams connecting adjacent walls in the plurality of walls.

In a twenty-fourth embodiment, the present disclosure provides the process of the twenty-third embodiment, further comprising applying the article to a first substrate.

In a twenty-fifth embodiment, the present disclosure provides a process for making the article of any one of the first to fifteenth embodiments, the process comprising:
applying tension to a film to make the spacer article, wherein the film has a first direction and a second direction transverse to the first direction and defines a pretensioned plane, the film comprising:
   a first plurality of slits through the film, wherein the first plurality of slits form a first row extending across the film in the second direction, and wherein each slit in the first plurality of slits extends from a first terminal end to a second terminal end; and
   a second plurality of slits through the film, wherein the second plurality of slits form a second row extending across the film in the second direction, wherein each slit in the second plurality of slits extends between terminal ends, wherein a first terminal end segment defining the first terminal end of each slit in the first plurality of slits intersects a first imaginary line
connecting the terminal ends of a first slit in the second plurality of slits, wherein when the tension is applied along the first direction, a plurality of regions of the polymer film rotate relative to the pretensioned plane to form the plurality of walls spaced apart from each other and the plurality of beams connecting adjacent walls in the plurality of walls;
applying the spacer article to the first substrate; and
applying the second substrate to the spacer article.

In a twenty-sixth embodiment, the present disclosure provides the process of the twenty-fourth or twenty-fifth embodiment, wherein applying the spacer article to the first substrate comprises at least one of adhering or fastening the spacer article to the first substrate.

In a twenty-seventh embodiment, the present disclosure provides the process of the twenty-fifth or twenty-sixth embodiment, wherein applying the spacer article to the second substrate comprises at least one of adhering or fastening the spacer article to the second substrate.

In a twenty-eighth embodiment, the present disclosure provides use of an expandable slit film as a rainscreen between building sheathing and building cladding, the expandable slit film comprising a film having a pretensioned state defining a pretensioned plane and a plurality of slits through the film, wherein when tension is applied to the slit film, a plurality of regions of the polymer film rotate relative to the pretensioned plane to form a rainscreen comprising a plurality of walls spaced apart from each other and a plurality of beams connecting adjacent walls in the plurality of walls.

In a twenty-ninth embodiments, the present disclosure provides the use of the twenty-eighth embodiment, wherein there are openings between the plurality of beams extending through the rainscreen.

In a thirtieth embodiment, the present disclosure provides the use of the twenty-eighth or twenty-ninth embodiment, wherein the openings between the plurality of beams allow airflow in a first direction and wherein openings in at least some portions of the plurality of walls allow airflow in a second direction transverse to the first direction.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all parts, percentages, ratios, etc. in the Examples and the rest of the specification are by weight. The following abbreviations are used in this section: centimeter=cm, mm=millimeter, ft=foot, m=meter, in =inch, Hz=Hertz, psi=pressure per square inch, kPa=kilo Pascal, and min=minutes.

TABLE 1
Materials List

| Abbreviation | Description and Source |
|---|---|
| TPO | Thermoplastic polyolefin, obtained under the trade designation, |
| | “ADFLEX Q 402 F”, obtained from LyondellBasell, Houston, TX |
| PP | Polypropylene, obtained under the trade designation, |
| | “ADSTIF HA802H”, from LyondellBasell, Houston, TX |
| YP | 15% yellow pigment masterbatch in LDPE, obtained under the |
| | trade designation “CC10341338WE”, from Avient, Avon Lake, OH |
| WP | White pigment masterbatch, obtained under the trade designation, |
| | “4048 VAC WHITE”, from PolyOne Inc., Avon Lake, OH |
| LDPE | Polyethylene, obtained under the trade designation, |
| | “DOW Polyethylene 6401”, from Dow Chemical, Midland, MI |
| PET Film | 3-mil (76.2-micrometer) polyethylene terephthalate (PET) |
| | film, obtained from Mitsubishi Chemical Americas, New York, NY |
| WPET Film | 7-mil (178-micrometer) PET film, obtained from Mitsubishi Chemical |
| | Americas under the trade designation “HOSTAPHAN W54B” Film |
| PSA | Acrylic Pressure Sensitive Adhesive Transfer Tape (ATT), |
| | obtained from 3M Company, St. Paul, MN, under the trade |
| | designation “3M SCOTCH ATG ADHESIVE TRANSFER TAPE 924” |

### Films A to D

Films A to D were prepared using blown film extrusion technology with the film constructions and processing conditions reported in Table 2 (see below). Seven-layer films were produced using a seven-layer pancake stack die (Type LF-400 Coex 7-layer co-extruder from Labtech Engineering, Praksa Muang, Thailand). Airflow to the die was manually controlled to achieve a blow-up ratio of approximately 2 to 1. The bubble was subsequently collapsed approximately 6-ft (2-in) above die, traversed though rollers, slit on the edges to produce two independent films, each of which were then wound onto a 3-in (7.5-cm) core and rolled up. The feed materials were supplied by 7 independent (0.75-in) 20-mm diameter extruders (Single Screw Extruder Type LE20-30/C HA from Labtech Engineering, Praksa Muang, Thailand). Layers 1-7 were fed using polymer pellets and masterbatch compound blends as is known in the art. The overall caliper of the samples was controlled through line speed adjustments from the web handling system.

TABLE 2
Blown Film Compositions and Process Conditions

| Film | A | B | C | E | 5 |
|---|---|---|---|---|---|
| Layer 1 Composition | LDPE | LDPE | LDPE | 80 TPO:20 YP | 75 PP:25 TPO |
| Extruder 1 RPM | 30 | 30 | 30 | 25 | 36 |
| Layer 2 Composition | LDPE | LDPE | LDPE | 95 TPO:5 WP | 75 PP:25 TPO |
| Extruder 2 RPM | 30 | 30 | 30 | 5 | 36 |
| Layer 3 Composition | LDPE | LDPE | LDPE | 47.5 TPO:47.5 | 75 PP:25 TPO |
| | | | | PP:5 WP | |
| Extruder 3 RPM | 30 | 30 | 30 | 45 | 36 |
| Layer 4 Composition | LDPE | LDPE | LDPE | 95 PP:5 WP | 75 PP:25 TPO |
| Extruder 4 RPM | 30 | 30 | 30 | 60 | 45 |
| Layer 5 Composition | LDPE | LDPE | LDPE | 47.5 TPO:47.5 | 75 PP:25 TPO |
| | | | | PP:5 WP | |
| Extruder 5 RPM | 30 | 30 | 30 | 45 | 45 |
| Layer 6 Composition | LDPE | LDPE | LDPE | 95 TPO:5 WP | 75 PP:25 TPO |
| Extruder 6 RPM | 30 | 30 | 30 | 5 | 45 |
| Layer 7 Composition | LDPE | LDPE | LDPE | 80 TPO:20 YP | 75 PP:25 TPO |
| Extruder 7 RPM | 30 | 30 | 30 | 25 | 45 |
| Die Temperature | 360 F. | 360 F. | 360 F. | 400 F. | 430 F. |
| Extruder Temperature | 360 F. | 360 F. | 360 F. | 400 F. | 430 F. |

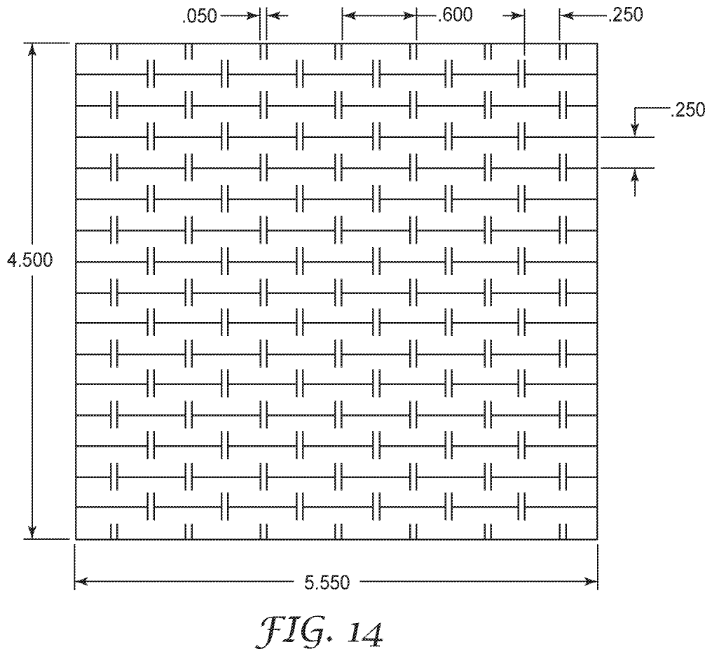

Films A to D were slit using a Model XLS 10.150D laser cutter (from Universal Laser Systems, Inc., Scottsdale, AZ) with the pattern shown in FIG. 14. The slit patterns were cut using 80% to 100% power with the z height set to 0. A default setting of “continuous cast acrylic” was used.

### Film E

Film E was PET Film laser slit as described for Films A to D.

### Film Example 1 (Ex. 1)

Film Example 1 was prepared and laser slit in a similar manner to Films A to D; however, a blown film die insert was used to induce longitudinal structure in the down-web direction of the films. Film Example 1 was produced using blown film die inserts as disclosed in U.S. Pat. No. 7,137,736 (Pawloski et al.) and U.S. Pat. No. 9,090,005 (Libby et al.). Film constructions and processing conditions were as reported Table 2, above. Film Example 1 was laser slit similar to Films A to D, with the longitudinal structures having a vertical orientation as presented in FIG. 15. When Film Example 1 was activated under tension, the structures oriented vertically as shown in FIG. 16.

### Film Examples 2 to 4 (Ex. 2 to Ex. 4)

For Film Examples 2 to 4, WPET Film was laser slit using a similar procedure as Films A to D, with modified slitting geometries. Film Example 2 was slit with the same pattern as FIG. 14, however with edge flaps 365 as depicted in FIG. 8. PSA was applied to the edge flaps 365 with a dispenser obtained from 3M Company under the trade designation “3M ATG 700” slitting. Film Example 3 was laser slit with a similar pattern to FIG. 14, however with non-slit cross web section 360 as depicted in FIG. 10. PSA was applied to the non-slit cross web section 360 of the film with the “3M ATG 700” dispenser. Film Example 4 was laser slit with a similar pattern to FIG. 14, however with non-slit edges 370 as depicted in FIG. 12. PSA was applied to the non-slit edge sections 370 of the film with the “3M ATG 700” dispenser. Film Examples 2 to 4 were 254 mm by 143 mm, 279 mm by 108 mm, and 305 mm by 102 mm, respectively, and portions were cut for Mechanical Compression evaluation as described below.

### Caliper Measurements

Film caliper measurements were taken for Films A to E and Film Examples 1 to 4 using a Mitutoyo Electric Drop Indicator with a 0.5-in diameter circular platen. For Film Example 1, the measurement was taken on the raised structures. The results are shown in Table 3, below.

### Mechanical Compression Test of Spacers

Mechanical compression testing was completed using an MTS Testing System (MTS Insight Electromechanical—1 kN Standard Length model, MTS, Eden Prairie, MN) according to ASTM D6364-06. Samples of Films A to E and Film Examples 1 to 4 were expanded from a length of 4 inches (101.6 mm) to 6.5 inches (152.4 mm) inducing a 0.25-in (6.35 mm) height 3D structure. 0.25 inches (6.35 mm) on each edge were not stretched. The tension-activated Spacers A to E and Examples 1 to 4 were placed between 5.5-in diameter platens, secured with tape on the edges, and compressed at a rate of 0.0394-in/min (1 mm/min). The resulting force and displacement data were collected at a 10 Hz rate and was used to create stress-strain curves according to ASTM D6364-06. The mechanical strength for the samples were evaluated according to ASTM E2925-19a. The results are shown in Table 3, below.

TABLE 3
Measurements for Caliper and Mechanical Strength

| | | Mechanical Strength |
|---|---|---|
| | Film Caliper | ASTM E2925-19a |
| | mils | Max Stress within |
| Spacer | (micrometers) | first 10% Strain (kPa) |
| A | 3.7 (94) | 1.06 |
| B | 7.9 (201) | 9.65 |
| C | 10.1 (257) | 15.76 |
| D | 7.2 (183) | 20.07 |
| E | 3.1 (79) | 18.57 |
| Ex. 1 | 15.1 (384) | 30.09 |
| Ex. 2 | 7 (178) | 44.02 |
| Ex. 3 | 7 (178) | 28.71 |
| Ex. 4 | 7 (178) | 43.87 |

Various modifications and alterations of this disclosure may be made by those skilled in the art without departing from the scope and spirit of this disclosure, and it should be understood that this disclosure is not to be unduly limited to the illustrative embodiments set forth herein.

1. An article comprising
a first substrate;
a second substrate; and
a spacer between the first substrate and the second substrate, the spacer comprising a plurality of walls spaced apart from each other and a plurality of beams connecting adjacent walls in the plurality of walls, with openings between the plurality of beams extending through the spacer,
wherein each wall in the plurality of walls comprises multiple first, second, and third wall portions, wherein the first and second wall portions are not parallel to each other and each have top and bottom opposing edges that define a height of the wall, wherein the top edges contact the first substrate and the bottom edges contact the second substrate, wherein the third wall portions have top edges continuous with the top edges of the first and second wall portions but a smaller height than the height of the wall, wherein the first, second, and third wall portions each have a thickness that is the smallest dimension of the wall portion, wherein at a given plane intersecting a first wall portion or second wall portion and perpendicular to the top edge and the bottom edge, a thickness of at the top edge is plus or minus ten percent of a thickness at the bottom edge, and wherein the third wall portions are connected with at least some of the plurality of beams connecting the adjacent walls.

2. The article of claim 1, wherein at least one of the first substrate or the second substrate comprises brick, concrete, stone, or a panel comprising at least one of wood, vinyl, metal, cement board, or a polymer composite.

3. The article of claim 1, wherein at least one of the first substrate or the second substrate is curved.

4. The article of claim 1, wherein each wall in the plurality of walls further comprises fourth wall portions, wherein the fourth wall portions have bottom edges continuous with the bottom edges of the first and second wall portions but a smaller height than the height of the wall, and wherein the fourth wall portions are connected with others of the plurality of beams connecting the adjacent walls.

5. The article of claim 4, wherein the adjacent walls comprise first and second walls, and
wherein the at least some of the plurality of beams connect to the third wall portions of the first and second walls, and wherein the others of the plurality of beams connect to the fourth wall portions of the first wall and a third wall, opposite the second wall, or
wherein the at least some of the plurality of beams connect to the third wall portions of the first wall and to the fourth wall portions of the second wall, wherein the others of the plurality of beams connect to the fourth wall portions of the first wall and to the third wall portions of a third wall.

6. The article of claim 1, wherein the plurality of beams further comprises a ribbon having an undulating shape.

7. An article comprising:
a film having a first direction and a second direction orthogonal to the first direction and defining a plane, the film comprising:
a first plurality of slits through the film, wherein the first plurality of slits form a first row extending across the film in the second direction, and wherein each slit in the first plurality of slits extends from a first terminal end to a second terminal end, wherein the first terminal end is in a portion of the slit that extends in the first direction, and wherein the second terminal end is in a portion of the slit that extends in the first direction;
a second plurality of slits through the film, wherein the second plurality of slits form a second row extending across the film in the second direction, wherein each slit in the second plurality of slits extends between terminal ends, wherein the terminal ends are each in a portion of the slit that extends in the first direction, wherein a first terminal end segment defining the first terminal end of each slit in the first plurality of slits intersects a first imaginary line connecting the terminal ends of a first slit in the second plurality of slits;
a rectangular region with a first axis in the first direction and a second axis in the second direction, wherein the rectangular region does not encompass the first terminal end or the second terminal end of any of the first plurality of slits or the terminal ends of any of the second plurality of slits; and
an adhesive disposed in the rectangular region on at least one surface of the film.

8. The article of claim 7, further comprising:
a third plurality of slits through the film, wherein the third plurality of slits form a third row extending across the film in the second direction, and wherein each slit in the third plurality of slits extends from a first terminal end to a second terminal end, wherein the first terminal end is in a portion of the slit that extends in the first direction, and wherein the second terminal end is in a portion of the slit that extends in the first direction; and
a fourth plurality of slits through the film, wherein the fourth plurality of slits form a fourth row extending across the film in the second direction, wherein each slit in the fourth plurality of slits extends between terminal ends, wherein the terminal ends are each in a portion of the slit that extends in the first direction, wherein a first terminal end segment defining the first terminal end of each slit in the third plurality of slits intersects a first imaginary line connecting the terminal ends of a first slit in the fourth plurality of slits, wherein the third plurality of slits and the fourth plurality of slits form a mirror image of the first plurality of slits and the second plurality of slits, wherein the rectangular region is a ribbon region extending across the film in the second direction between the second plurality of slits and the third plurality of slits, wherein the rectangular region does not encompass the first terminal end or the second terminal end of any of the third plurality of slits or the terminal ends of any of the second plurality of slits.

9. An article comprising:
a film having a first direction and a second direction orthogonal to the first direction and defining a plane, the film comprising:
raised structures extending in the first direction and spaced apart from each across the film in the second direction;
a first plurality of slits through the film and through the raised structures, wherein the first plurality of slits form a first row extending across the film in the second direction, and wherein each slit in the first plurality of slits extends from a first terminal end to a second terminal end, wherein the first terminal end is in a portion of the slit that extends in the first direction, and wherein the second terminal end is in a portion of the slit that extends in the first direction; and
a second plurality of slits through the film, wherein the second plurality of slits form a second row extending across the film in the second direction, wherein each slit in the second plurality of slits extends between terminal ends, wherein the terminal ends are each in a portion of the slit that extends in the first direction, wherein a first terminal end segment defining the first terminal end of each slit in the first plurality of slits intersects a first imaginary line connecting the terminal ends of a first slit in the second plurality of slits.

10. The article of claim 9, wherein each slit in the first plurality of slits and the second plurality of slits comprises more than two terminal ends.

11. The article of claim 9, wherein the film comprises at least one of a polymer, a metal, or multiple polymer layers.

12-15. (canceled)
